(19) United States
(12) Patent Application Publication
(10) Pub. No.: US 2009/0002818 A1
(43) Pub. Date: Jan. 1, 2009

(54) Rear Surface Projection Type Screen and Rear Surface Projection Type Display Device

(75) Inventors: Hiroki Iwabu, Niigata (JP); Yoshihiro Kumagai, Niigata (JP); Youji Ono, Niigata (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KURARAY CO., LTD, Okayama (JP)

(21) Appl. No.: 11/908,236

(22) PCT Filed: Feb. 28, 2006
(86) PCT No.: PCT/JP2006/303697

§ 371 Date: Sep. 10, 2007

(30) Foreign Application Priority Data
Mar. 8, 2005 (JP) 2005-064015
Apr. 20, 2005 (JP) 2005-122955

(51) Int. Cl. G03B 21/62

(52) U.S. Cl. 359/457; 359/456

(57) ABSTRACT

There are provided a rear projection screen and a rear projection display apparatus capable of achieving a large lenticular pitch Lp and a high pitch ratio Gp/Lp and suppressing moire. The rear projection screen includes a plurality of pixels with an outer edge having a rhombus shape inclined with respect to a horizontal direction and a vertical direction of a screen of the rear projection screen, and a lenticular lens sheet diffusing light emitted from a rear projection projector within a certain angle range. The plurality of pixels are arranged in such a way that their outer edges are adjacent to each other, a lens pitch Lp (mm) of the lenticular lens sheet satisfies Lp≧0.15, and a pitch ratio Gp/Lp of a pitch Gp (mm) of the pixels and the lens pitch Lp satisfies Gp/Lp≧1.0.

### TECHNICAL FIELD

The present invention relates to a rear projection screen and a rear projection display apparatus and, particularly, to a rear projection screen and a rear projection display apparatus used for a rear projection television or the like.

### BACKGROUND ART

A rear projection screen has been generally used in a rear projection television. A typical rear projection screen has a rear projection projector, a Fresnel lens, and a lenticular lens in vertical stripe arrangement. In such a rear projection screen, moire interference occurs due to the periodic structure of the screen and the pixels projected onto the screen. Thus, the pitch ratio of a pixel pitch Gp and a lens pitch of a lenticular lens (which is abbreviated hereinafter as a lenticular pitch Lp) is optimized.

For example, preferred combinations of the pitch ratio of the pixel pitch and the lenticular pitch (pixel pitch/lenticular pitch, which is abbreviated as Gp/Lp) are disclosed in patent documents 1 to 6. The patent document 1 discloses that a preferred pitch ratio Gp/Lp is approximately 1.5. Further, the patent document 1 discloses that a pitch ratio Gp/Lp of 2 or higher is preferred. The patent document 2 discloses that n+0.25<Gp/Lp<n+0.75 (n is an integer of 1 or larger) is preferred. However, those documents focus on obtaining a preferred range of the pitch ratio Gp/Lp rather than overcoming moire interference.

Recently, it is required for a rear projection screen that the pitch ratio Gp/Lp is 6 or higher. For example, the patent document 3 proposes Lp<Gp and a moire pitch≦Gp. The patent document 4 proposes that the moire pitch of a lenticular lens and a Fresnel lens (which includes a high-order moire pitch) is 3 mm or lower. The patent document 5 proposes Gp/Lp=n+0.5 (n is an integer of 1 or larger).

In a screen of a rear projection television that is actually placed on the market as a product, a required pitch ratio Gp/Lp is high. For example, the pitch ratio Gp/Lp of a commercialized rear projection television is optimized to 7.13, 10.2 or the like, and the pitch ratio Gp/Lp of 7 or higher is demanded.

Further, the prevention of screen glare is taken into account in recent rear projection screens, and there is an increasing demand for a higher pitch ratio Gp/Lp. For example, the patent document 6 discloses a technique of satisfying Gp/Lp≧4.0 in order to reduce glare. In addition, in order to meet the demand for higher-resolution projected images, there is a trend to increase the number of pixels, that is, to reduce the pixel pitch on a projection screen.

Given the requirement to achieve both a small pixel pitch Gp and a high pitch ratio Gp/Lp, it is necessary to reduce the lenticular pitch Lp. The reduction of the lenticular pitch Lp of a lenticular lens, however, causes various problems.

For example, in a mold cutting process that cuts a lens mold of a lenticular lens sheet, the reduction of the lenticular pitch Lp causes the distortion of a mold and the generation of burrs. In a molding process that molds a lens, the reduction of the lenticular pitch Lp causes a decrease in the thickness of a lenticular lens sheet, which results in failure of molding with a normal extrusion technique. Further, if there are mold patterns on both sides, it is difficult to allow them in phase.

Further, in a light shielding layer formation process that forms a light shielding portion, the reduction of the lenticular pitch Lp makes it difficult to perform screen printing and roll printing onto a projecting light shielding portion. Specifically, it is required to reduce the height of a projecting portion in order to avoid a decrease in outgoing light intensity. This results in a problem such as erroneous attachment of ink onto an output portion. Although the patent document 7 discloses a method of fine-pitch printing that transfers a light shielding layer with the use of adhesion, the process is complicated. In addition, because the self-selective exposure by a lenticular lens sheet is used in this technique, the existence of a foreign substance directly causes appearance defects. Further, in an inspection process after the formation of a lenticular lens sheet, automatic inspection is difficult if the lenticular pitch Lp is small, thus failing to perform effective quality control.

Furthermore, if the lenticular pitch Lp is small, the thickness of a lenticular lens sheet is generally small. If a lenticular lens sheet is thin, the sheet is not self-sustainable. It is thus necessary to sandwich the sheet between more rigid sheets or to adhere the sheet to a more rigid sheet. This increases the number of elements of the sheet and increases the manufacturing process.

Therefore, a lenticular lens sheet of a recent rear projection screen is required to have the structure with a large lenticular pitch Lp to allow easy manufacture, in which moire due to interference with pixels is hardly visible. Further, it is required to have the structure in which glare is unobtrusive even if the lenticular pitch Lp is large. It is also required to have the structure in which a lenticular lens sheet can stand on its own.

Recently, a rear projection display apparatus using a DMD (Digital Micromirror Device) has been proposed. In such a rear projection display apparatus, light from a light source is applied to a DMD and then reflected light that is reflected by a mirror of the DMD is projected onto a rear projection screen through a lens. An example of a projector apparatus with the use of a DMD that projects light onto a rear projection screen is disclosed in the patent document 8.

In the projector apparatus with the use of a DMD that is disclosed in the patent document 8, DMDs are arranged in the same manner as the arrangement of pixels in one screen (frame) of video data to constitute a reflection plane of about the size of a ½-inch CCD. Based on image data, if a pixel becomes valid or invalid, each DMD is tilted to a given direction from the neutral state and is thereby turned ON or OFF.

The reflected light that is reflected by the reflection plane of the DMD in the ON-state is output through each lens to the outside of the projector apparatus. After that, the light produces an image on a video display surface of a video display target (not shown) such as a screen, thereby projecting a video on the video display surface.

In such a DMD, the mirror that reflects light is supported by a supporting unit. A driver device changes the reflection plane by controlling the mirror supported by the supporting portion. The supporting unit is supported at the backside of the reflection plane of the mirror, and the reflection and diffusion characteristics, particularly the reflection angle, of the backside of a supporting portion, which is the reflection plane of the supporting portion, changes.

When a black screen (which is also referred to herein as a dark screen) is displayed, projected light is not reflected in the video viewing direction on a mirror surface. However, because the reflection characteristics of the reflection plane changes at the supporting portion of the supporting unit, the DMD mirror reflects light in an unintended direction. A part of the unintended reflected light is output reflected in the video viewing direction, and it is recognized as a luminescent spot in a pixel on the screen surface.

In a rear projection display apparatus using a DMD, a pixel where a luminescent spot occurs and a lenticular lens interfere with each other during the black screen display, causing the generation of moire interference. Further, because the luminescent spot of the pixel is very small and thus the degree of modulation is high, it is likely to interfere with the lenticular lens. The luminescent spot is significantly visible particularly when a black screen is displayed, and thus moire interference during the black screen display is likely to be visually recognized.

In the following description, moire in a black screen is referred to as dark moire. On the other hand, moire in a white display (which is also referred to herein as a light screen) is referred to as light moire.

[Patent document 1] Japanese Unexamined Patent Application Publication No. 62-236282
[Patent document 2] Japanese Unexamined Patent Application Publication No. 2-097991
[Patent document 3] Japanese Unexamined Patent Application Publication No. 2000-112035
[Patent document 4] Japanese Unexamined Patent Application Publication No. 2002-090889
[Patent document 5] Japanese Unexamined Patent Application Publication No. 9-027448
[Patent document 6] Japanese Unexamined Patent Application Publication No. 11-102024
[Patent document 7] Japanese Unexamined Patent Application Publication No. 9-120101
[Patent document 8] Japanese Unexamined Patent Application Publication No. 7-020586

### DISCLOSURE OF THE INVENTION

### Problems to be Solved by the Invention

In light of the foregoing, an object of the present invention is thus to provide a rear projection screen and a rear projection display apparatus which are capable of achieving a large lenticular pitch Lp and a high pitch ratio Gp/Lp and suppressing moire.

Further, in light of the foregoing, another object of the present invention is thus to provide a rear projection screen and a rear projection display apparatus which are capable of suppressing dark moire.

Further, in light of the foregoing, another object of the present invention is thus to provide a rear projection screen and a rear projection display apparatus which are capable of preventing the occurrence of moire even if the pitch ratio Gp/Lp is low.

### Means for Solving the Problems

According to the present invention, there is provided a rear projection screen that includes a plurality of pixels with an outer edge having a rhombus shape inclined with respect to a horizontal direction and a vertical direction of a screen of the rear projection screen, and a lenticular lens sheet diffusing light emitted from a rear projection projector within a certain angle range, wherein the plurality of pixels are arranged with the outer edge adjacent to each other, a lens pitch Lp (mm) of the lenticular lens sheet satisfies Lp≧0.15, and a pitch ratio Gp/Lp of a pitch Gp (mm) of the pixels and the lens pitch Lp satisfies Gp/Lp≧1.0.

In this structure, the plurality of pixels are arranged not in matrix along the horizontal and vertical directions but in the inclined positions with respect to those directions. This eliminates effective light and dark patterns in the vertical direction of a projection screen. Further, the above structure enables the pitch ratio Gp/Lp to be as large as 1 or higher. At the same time, the structure enables a decrease in the pixel pitch Gp and an increase in the lenticular pitch Lp to 0.15 mm or larger. It is thereby possible to achieve a large lenticular pitch Lp and pitch ratio Gp/Lp while suppressing moire interference. Particularly, this structure enables suppression of light moire.

Preferably, the pitch ratio Gp/Lp satisfies n+0.05≦Gp/Lp≦n+0.95 where n is a natural number. This enables suppression of moire even with a larger Lp. The pitch ratio Gp/Lp is preferably 1.5 or higher. If it is smaller than this value, there arises a problem in resolution.

More preferably, the pitch ratio Gp/Lp satisfies 1.30≦Gp/Lp≦1.70 or 2.30≦Gp/Lp.

Further preferably, the pitch ratio Gp/Lp satisfies 1.40≦Gp/Lp≦1.60 or 2.47≦Gp/Lp.

The pitch ratio Gp/Lp may satisfy n+0.15≦Gp/Lp≦n+0.85 (n=1, 2, 3) or 4.15≦Gp/Lp.

The pitch ratio Gp/Lp may further satisfy any one of 1.40≦Gp/Lp≦1.60, 2.47≦Gp/Lp≦2.85, 3.15≦Gp/Lp≦3.85, and 4.15≦Gp/Lp.

The above pitch ratio Gp/Lp prevents the occurrence of not only light moire but also dark moire.

The above lenticular lens sheet may include a lenticular lens placed on a side where light emitted from the rear projection projector is incident and diffusing the incident light within a certain angle range, and an output lens placed on a side where the incident light is output and diffusing light having passed through the lenticular lens within the certain angle range, wherein the pitch ratio Gp/Lp satisfies 1.30≦Gp/Lp≦1.90 or 2.20≦Gp/Lp.

In this structure, the plurality of pixels are arranged not in matrix along the horizontal and vertical directions but in the inclined positions with respect to those directions. This eliminates effective light and dark patterns in the vertical direction of a projection screen. Further, the structure enables a decrease in the pixel pitch Gp and an increase in the lenticular pitch Lp to 0.15 mm or larger. It is thereby possible to prevent the generation of moire even if the pitch ratio Gp/Lp is in a relatively small range. Particularly, this structure enables suppression of light moire.

Further preferably, the pitch ratio Gp/Lp satisfies any one of 1.34≦Gp/Lp≦1.70, 1.75<Gp/Lp<1.85, and 2.35≦Gp/Lp.

More preferably, the pitch ratio Gp/Lp satisfies 1.40≦Gp/Lp≦1.50 or 2.50≦Gp/Lp. The occurrence of light moire can be prevented with such a pitch ratio Gp/Lp.

The pitch ratio Gp/Lp may satisfy any one of 1.75<Gp/Lp<1.85, 2.55≦Gp/Lp≦2.90, and 3.40≦Gp/Lp. Such a pitch ratio Gp/Lp enables more reliable suppression of light moire.

Further, the pitch ratio Gp/Lp may satisfy 2.65≦Gp/Lp≦2.90 or 3.50≦Gp/Lp.

The above pitch ratio Gp/Lp prevents the occurrence of not only light moire but also dark moire.

The rear projection screen may further include a Fresnel lens sheet that narrows light emitted from the rear projection projector to a certain angle range together with the lenticular lens sheet, wherein the Fresnel lens sheet satisfies diffusion characteristics of ζ/α≦6 and γ/α≦2.8 where α indicates a half-viewing angle, γ indicates a 1/10-viewing angle, and ζ indicates a 1/100-viewing angle. This reduces speckle and avoids light loss. Hence, although glare is likely to appear when the pitch ratio Gp/Lp is small, it is possible to eliminate glare and achieve high transmittance characteristics.

Preferably, the Fresnel lens sheet satisfies diffusion characteristics of 2.0°≦α≦5.5°, γ≦12°, and ζ≦18°. This assures diffusibility and makes sure to reduce glare.

It is more effective if the Fresnel lens sheet has surface projections and depressions on an incident surface, and a center line average roughness Ra specified by JIS B 0601 satisfies 0.5 μm≦Ra≦2.0 μm.

A rear projection display apparatus according to the present invention includes the above-described rear projection screen. This structure eliminates effective light and dark patterns in the vertical direction of a projection screen; at the same time, it suppresses moire interference and achieves a large lenticular pitch Lp and a high pitch ratio Gp/Lp. This further enables suppression of not only light moire but also dark moire.

### ADVANTAGES OF THE INVENTION

According to the present invention, it is possible to provide a rear projection screen and a rear projection display apparatus which are capable of achieving a large lenticular pitch Lp and a high pitch ratio Gp/Lp and suppressing moire.

Further, according to the present invention, it is possible to provide a rear projection screen and a rear projection display apparatus which are capable of suppressing dark moire.

Furthermore, according to the present invention, it is possible to provide a rear projection screen and a rear projection display apparatus which are capable of preventing the occurrence of moire even when the pitch ratio Gp/Lp is low.

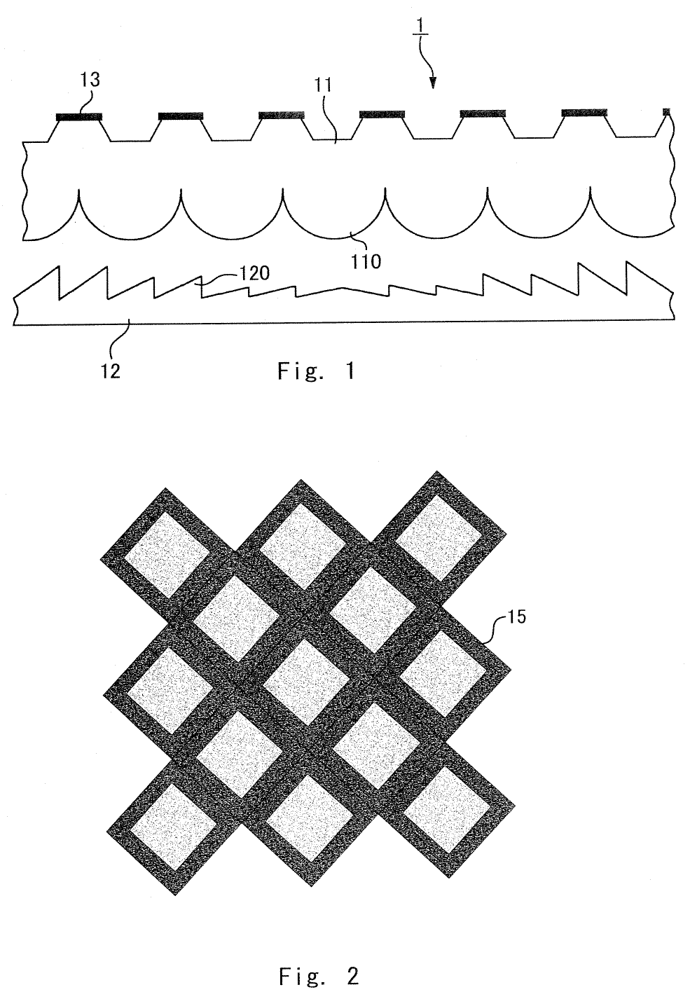

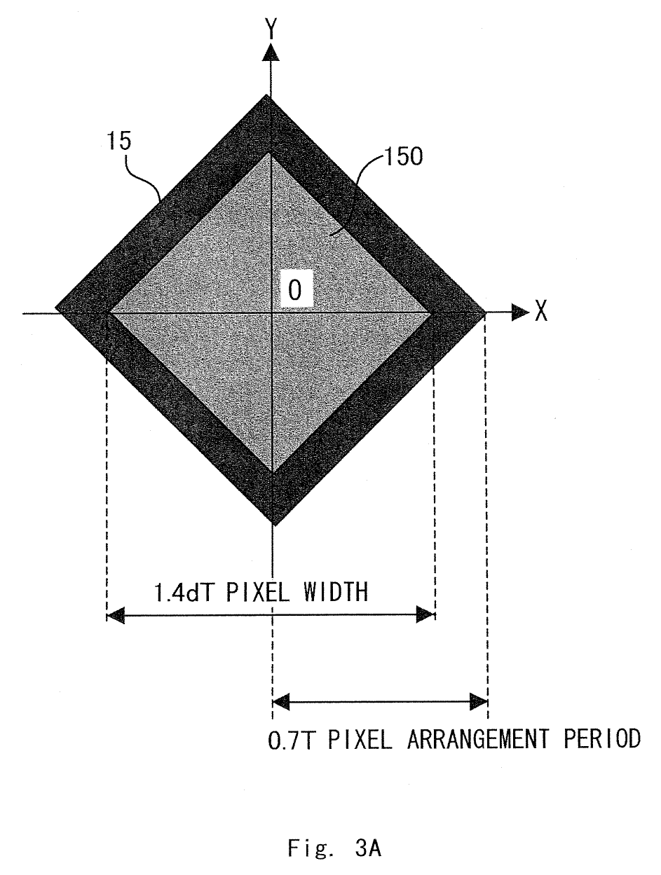

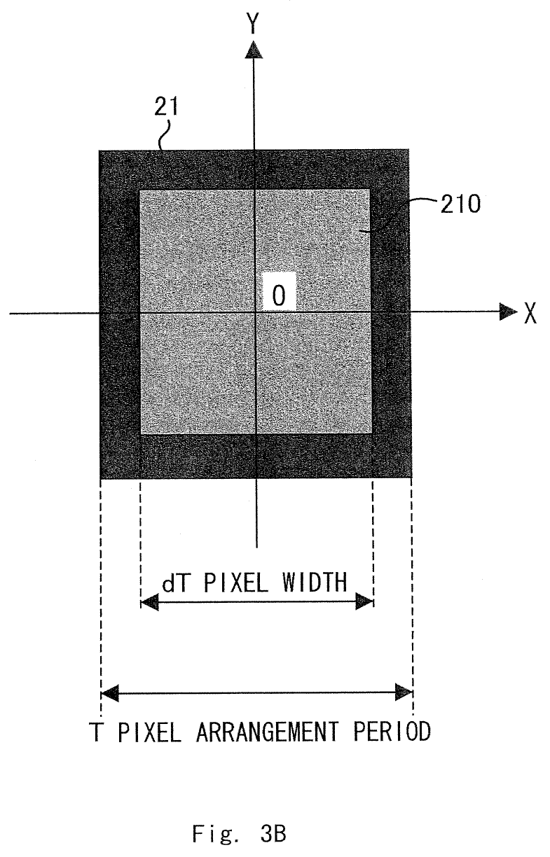

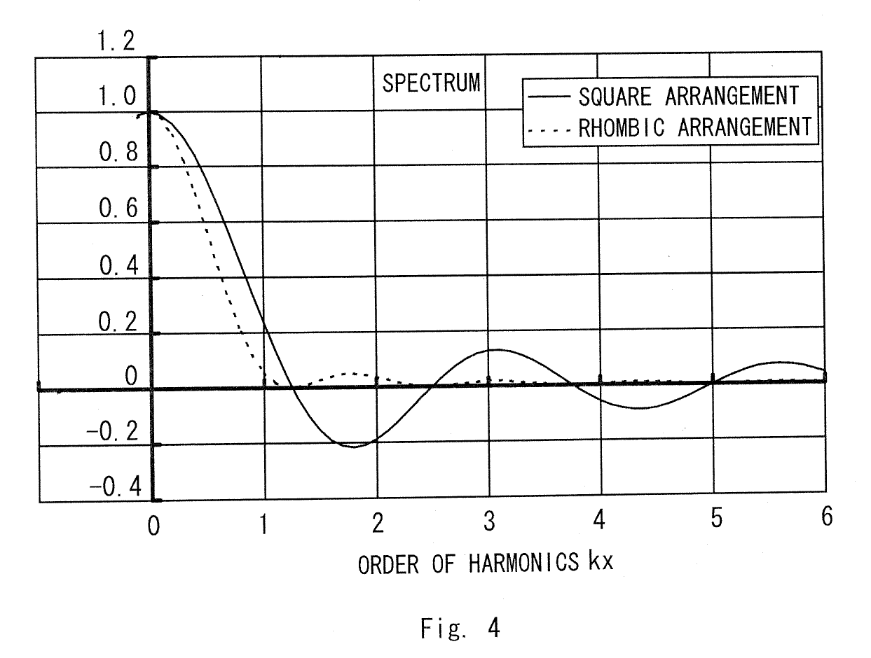

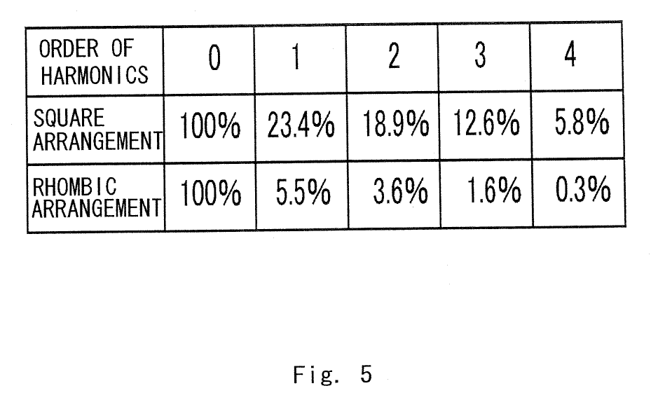

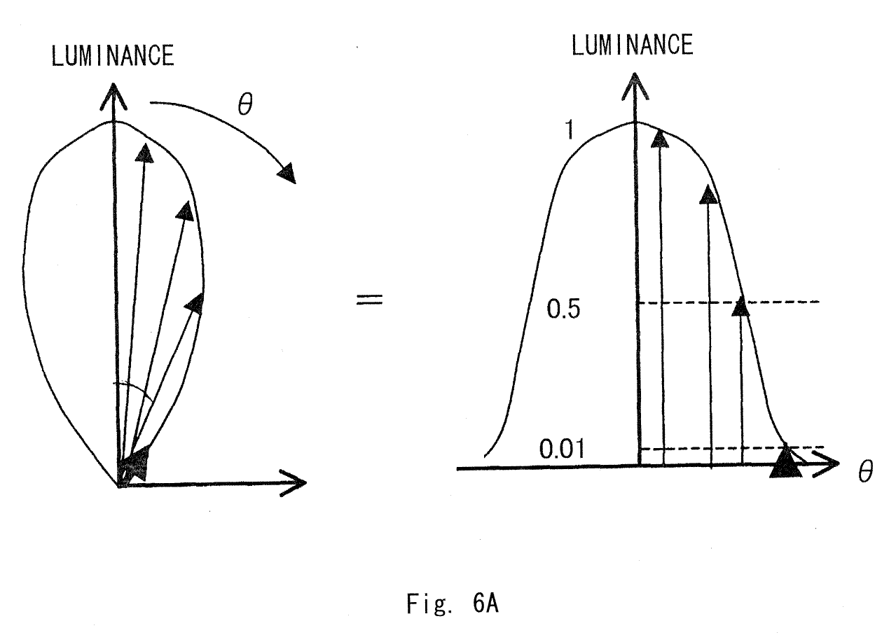

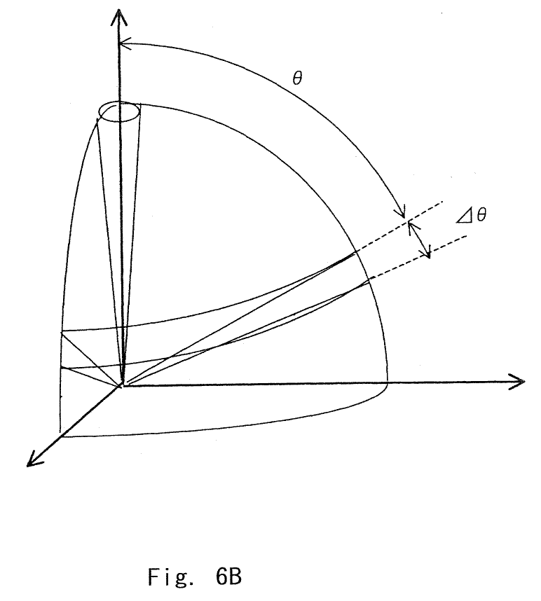

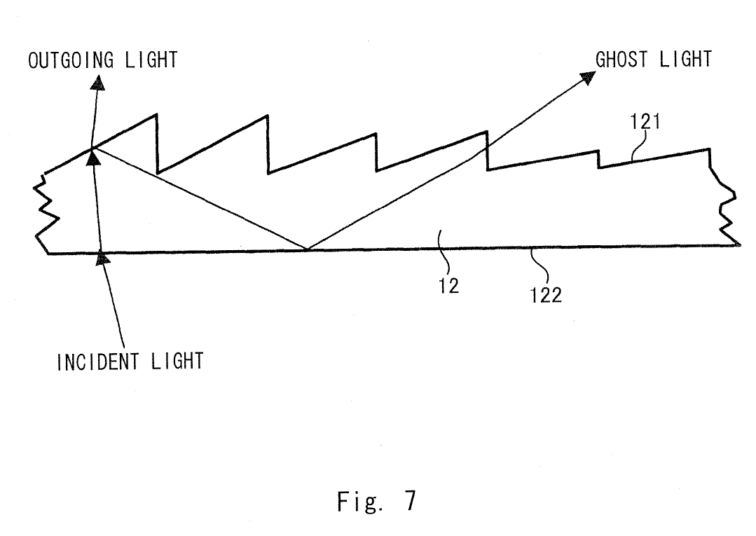

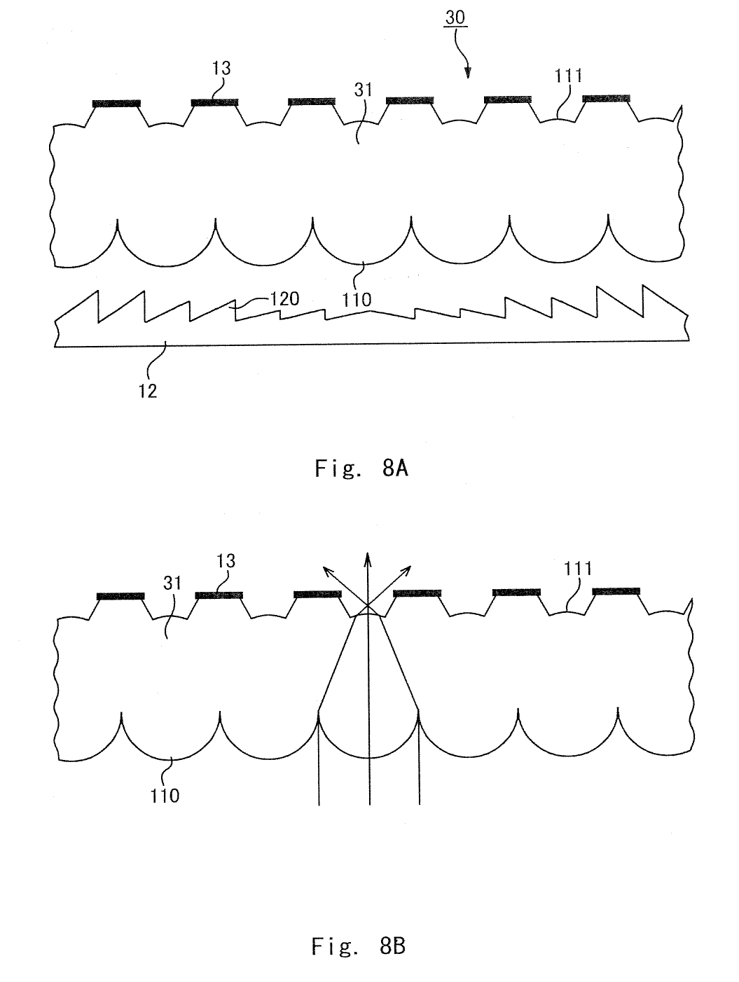

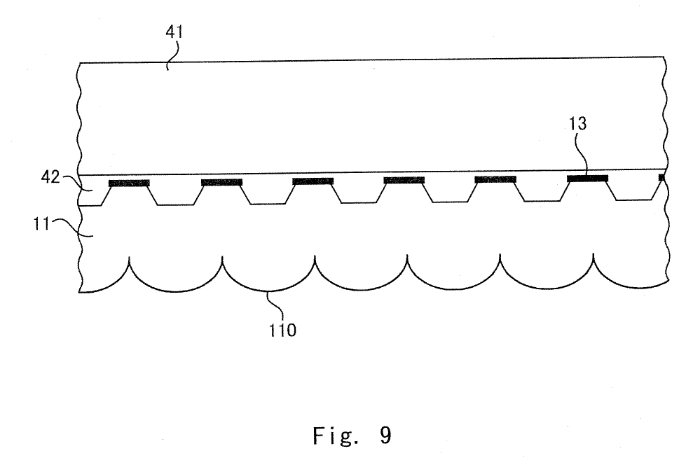

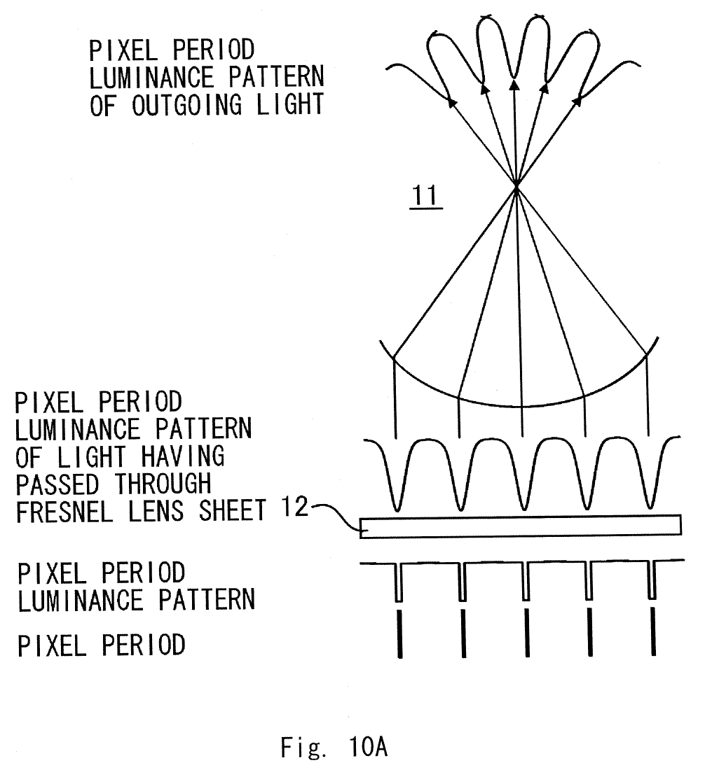

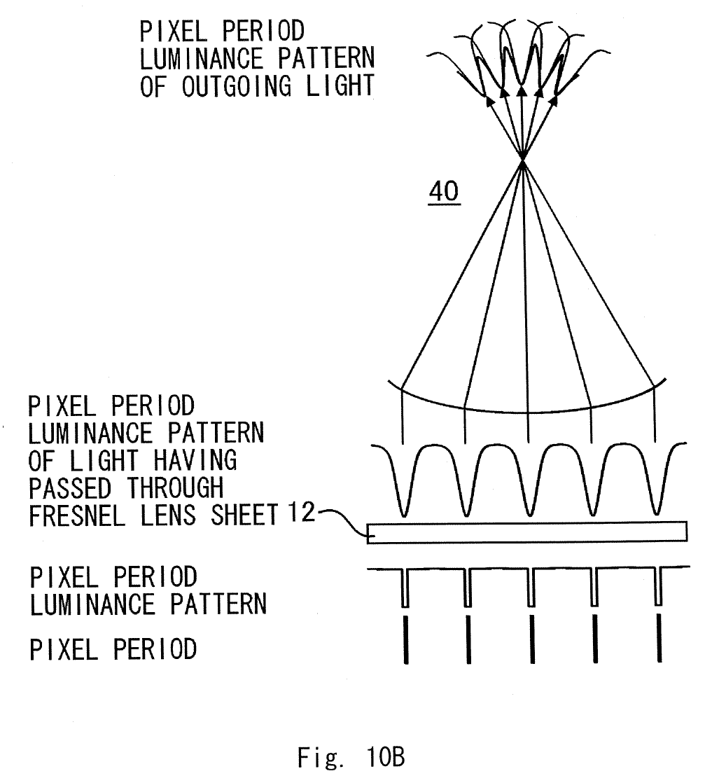

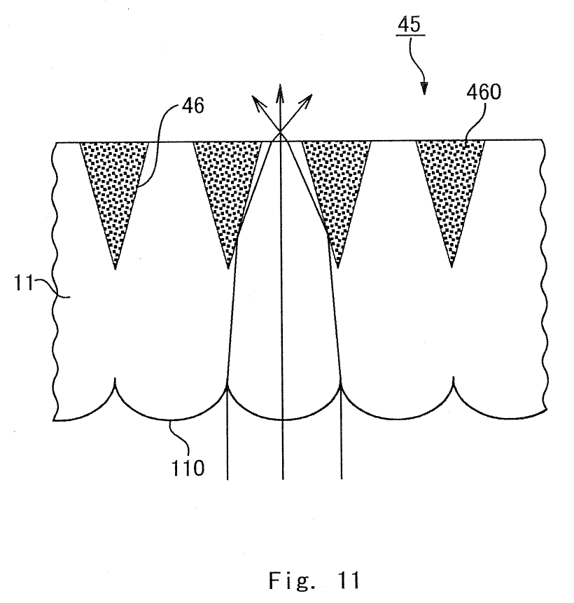

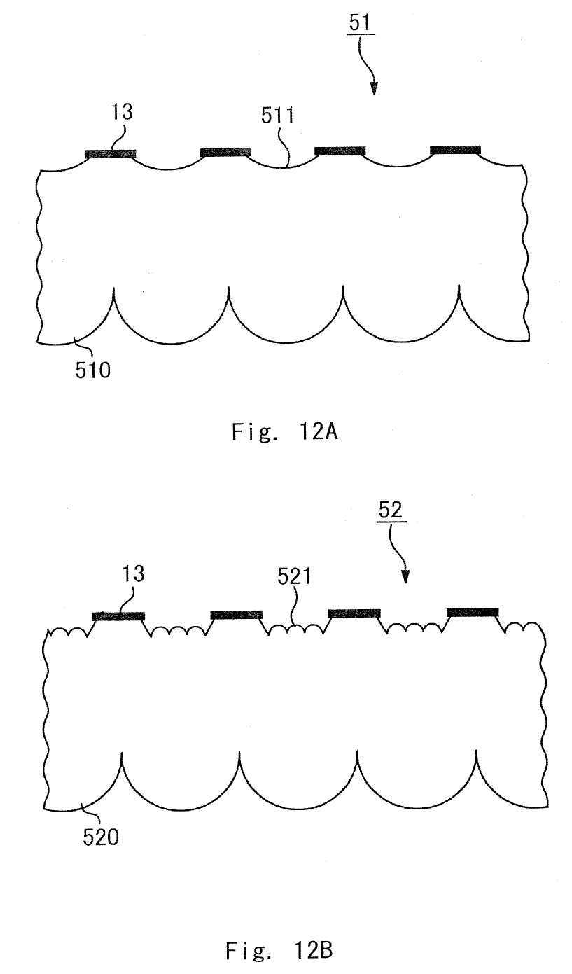

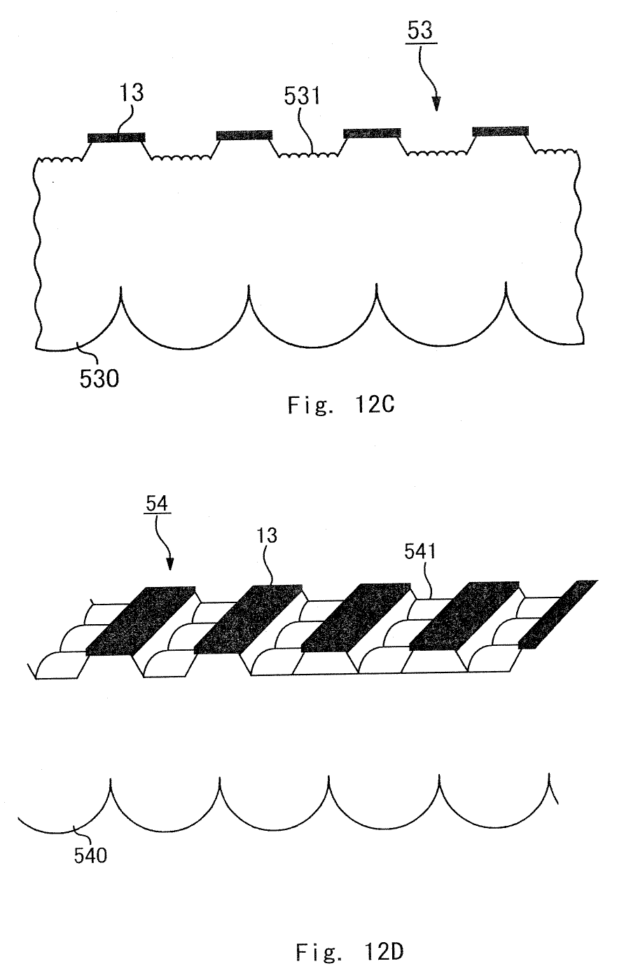

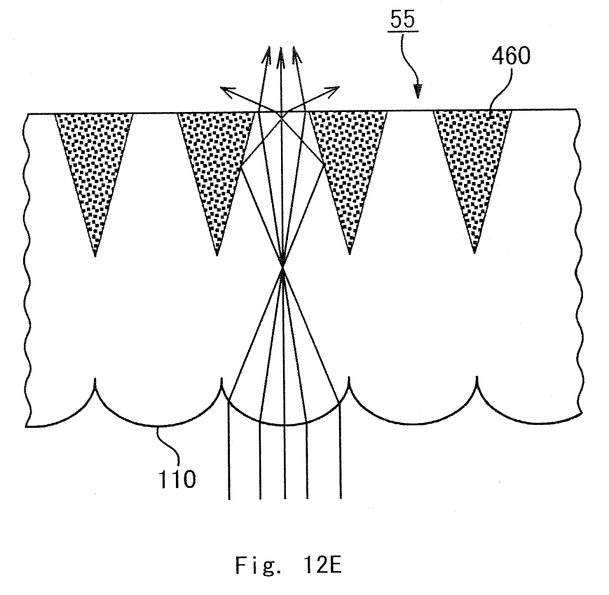

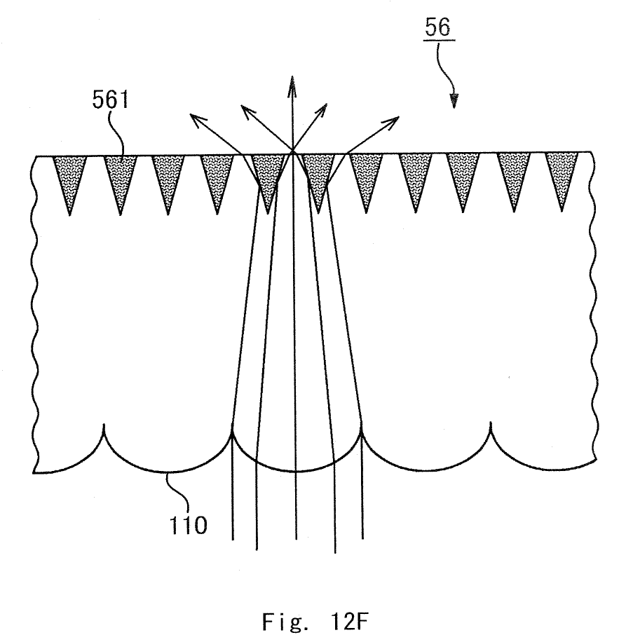

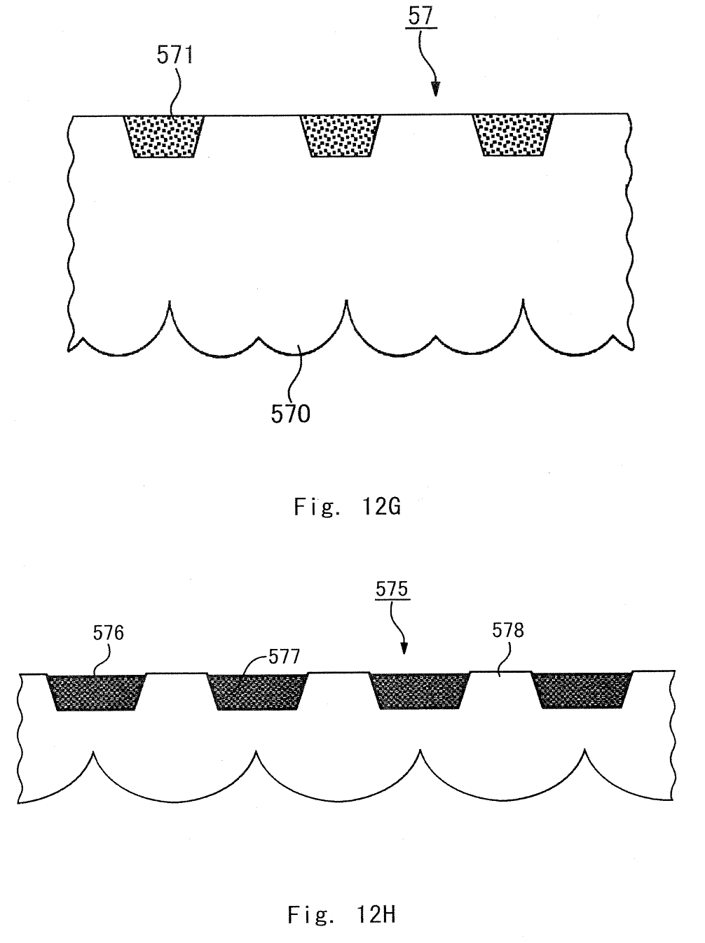

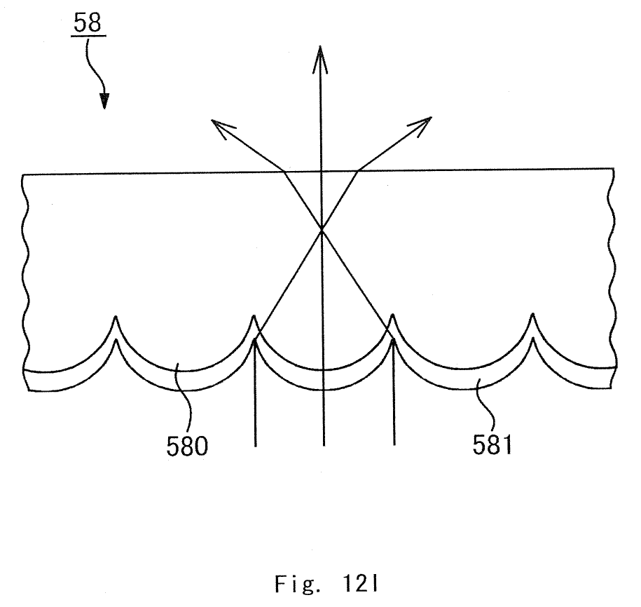

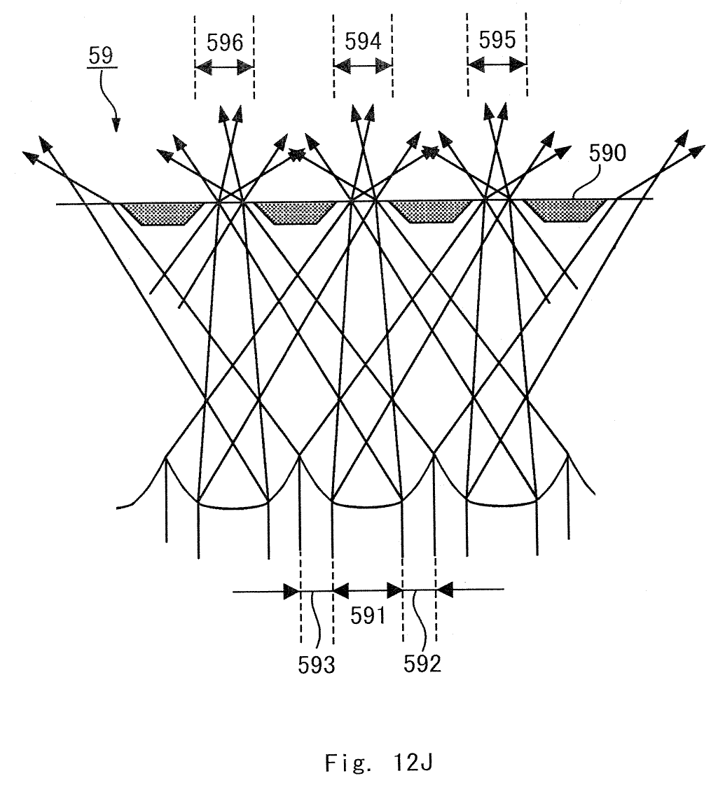

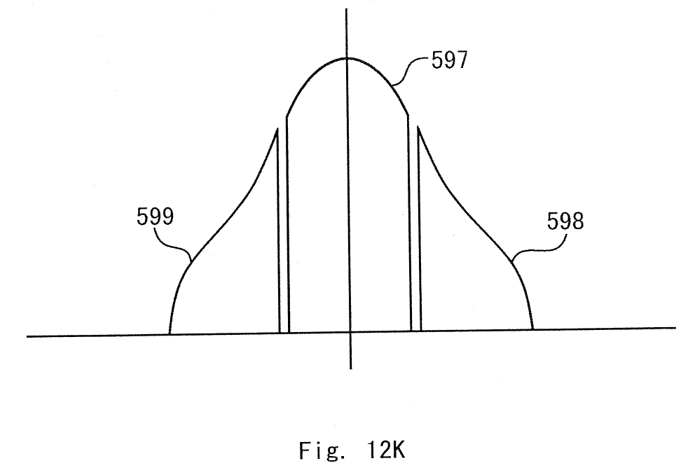

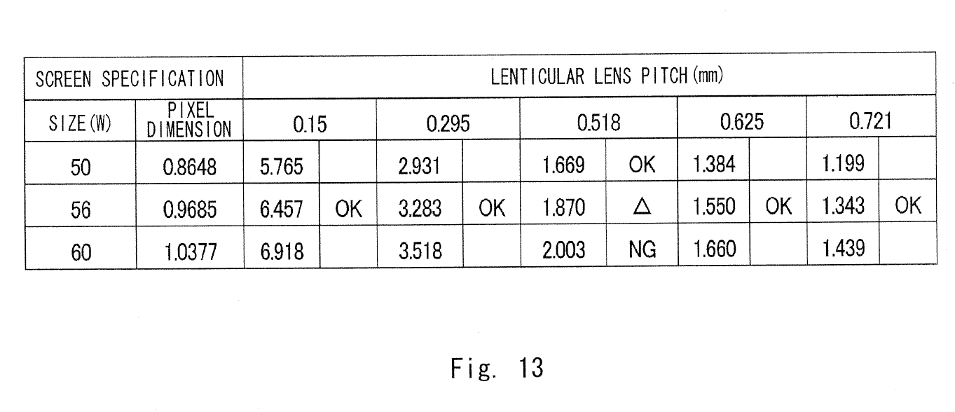

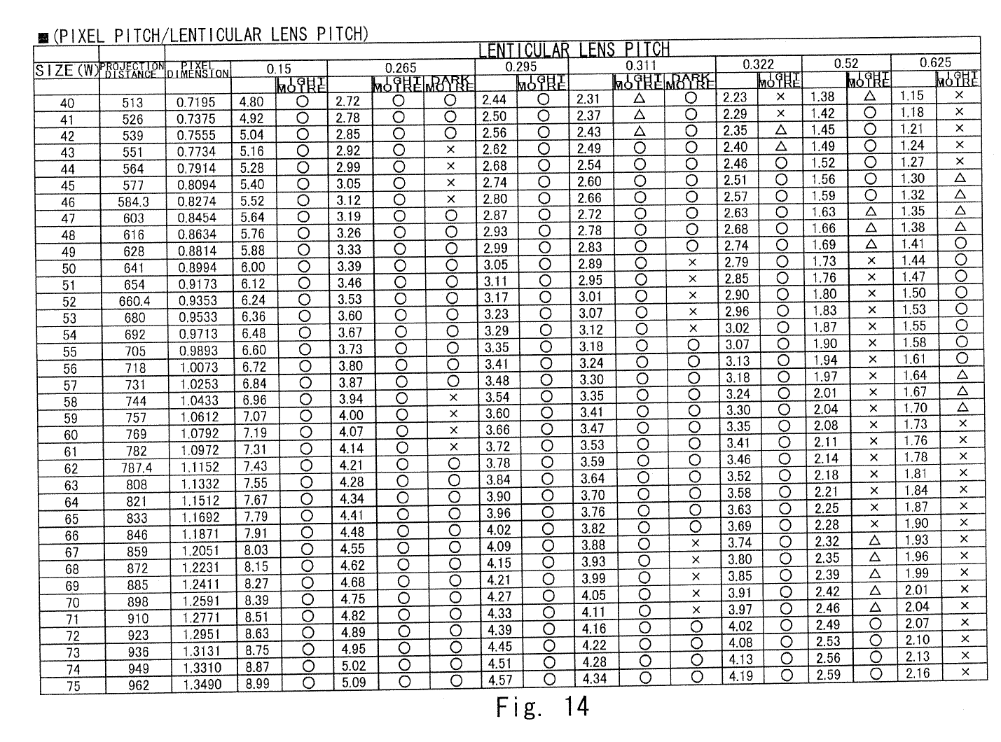

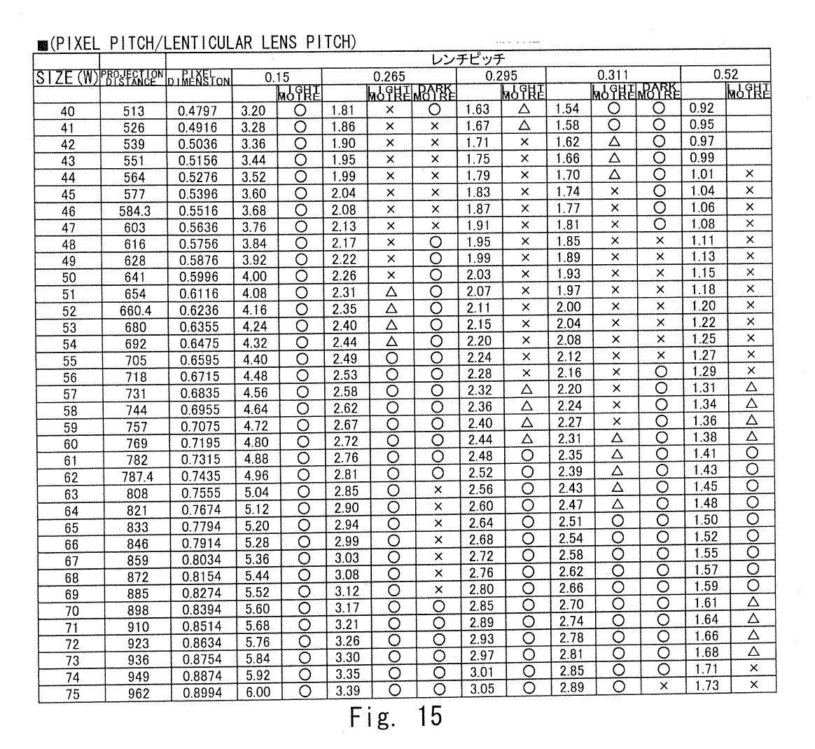

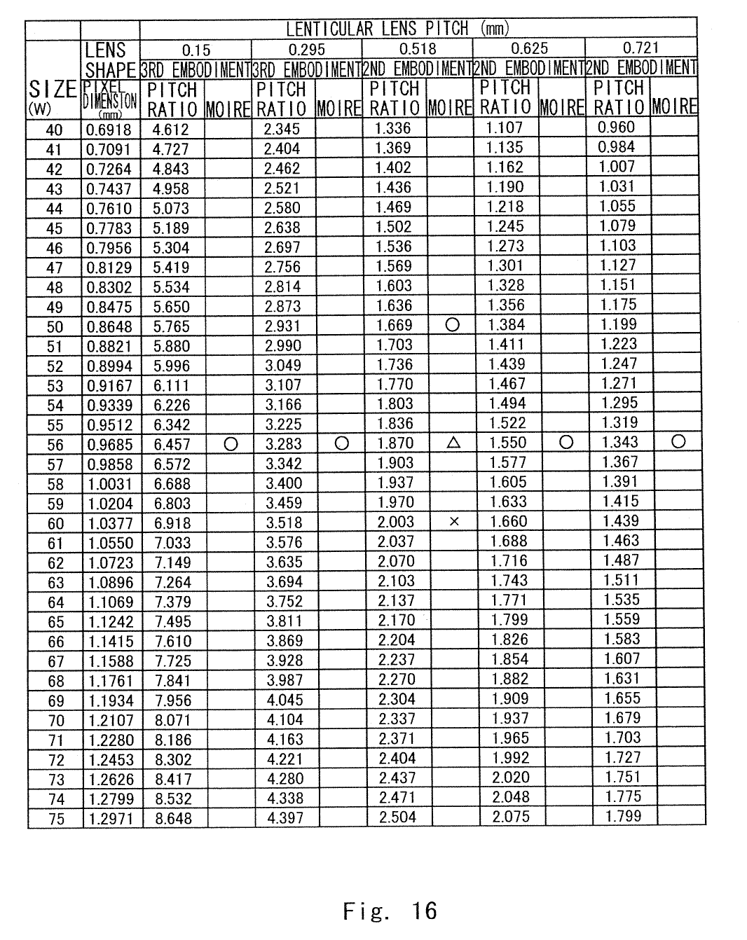

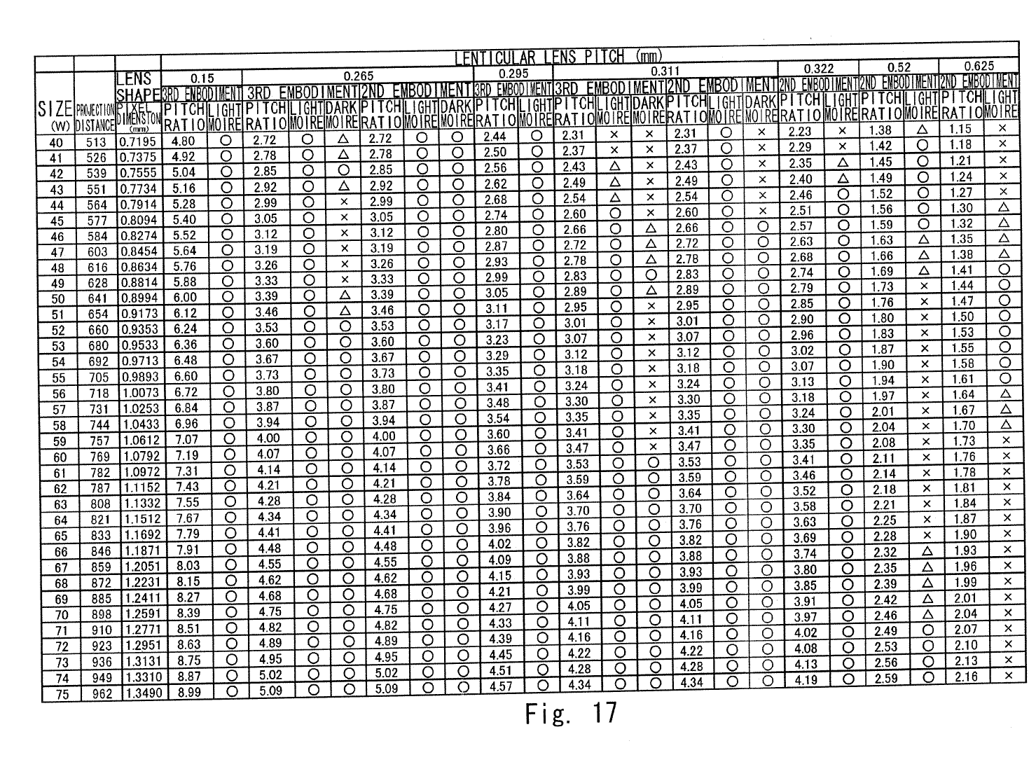

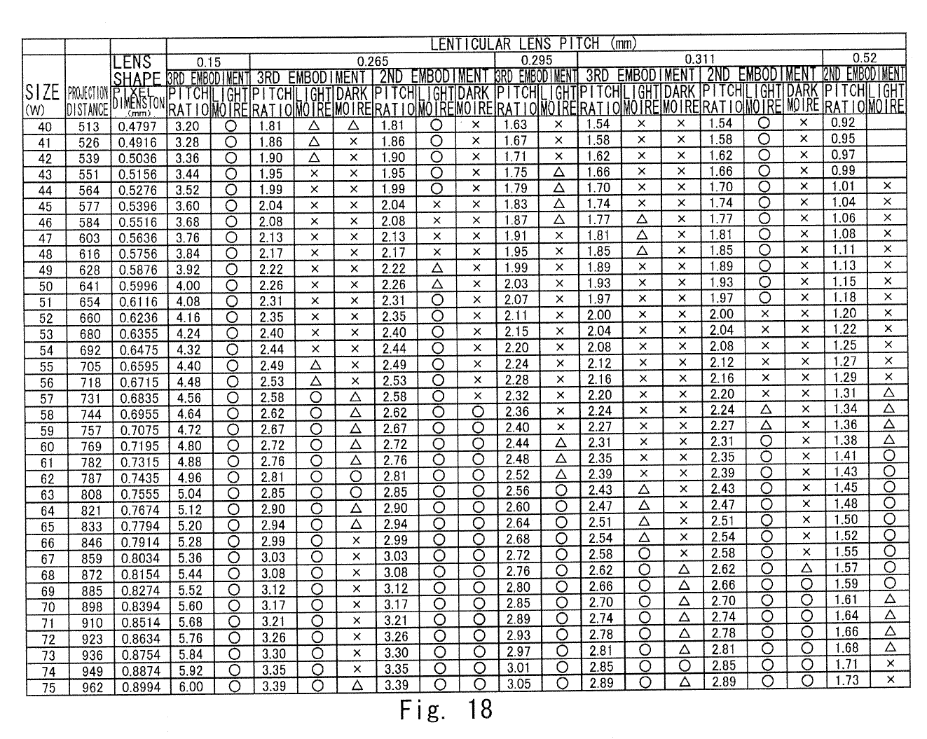

### BRIEF DESCRIPTION OF THE DRAWINGS

[FIG. 1] A schematic view showing an exemplary structure of a rear projection screen according to the present invention.

[FIG. 2] A schematic view showing an exemplary structure of a pixel of a rear projection screen according to the present invention.

[FIG. 3A] A schematic view showing an exemplary structure of a pixel of a rear projection screen according to the present invention.

[FIG. 3B] A schematic view showing an exemplary structure of a pixel of a rear projection screen according to a related art.

[FIG. 4] A graph showing a content of harmonics of a pixel of a rear projection screen according to the present invention.

[FIG. 5] A table showing a content of harmonics of a pixel of a rear projection screen according to the present invention.

[FIG. 6A] A schematic view to describe diffusion characteristics of a Fresnel lens sheet according to the present invention.

[FIG. 6B] A schematic view to describe diffusion characteristics of a Fresnel lens sheet according to the present invention.

[FIG. 7] A schematic sectional view showing an exemplary structure of a Fresnel lens sheet according to the present invention.

[FIG. 8A] A schematic view showing an exemplary structure of a lenticular lens sheet according to the present invention.

[FIG. 8B] A schematic view showing an exemplary structure of a lenticular lens sheet according to the present invention.

[FIG. 9] A schematic view showing an exemplary structure of a lenticular lens sheet according to the present invention.

[FIG. 10A] A schematic view showing a focal length and a contrast of a lenticular lens sheet according to a second embodiment.

[FIG. 10B] A schematic view showing a focal length and a contrast of a lenticular lens sheet according to a third embodiment.

[FIG. 11] A schematic view showing an exemplary structure of a lenticular lens sheet according to the present invention.

[FIG. 12A] A schematic view showing an exemplary structure of a lenticular lens sheet according to the present invention.

[FIG. 12B] A schematic view showing an exemplary structure of a lenticular lens sheet according to the present invention.

[FIG. 12C] A schematic view showing an exemplary structure of a lenticular lens sheet according to the present invention.

[FIG. 12D] A schematic view showing an exemplary structure of a lenticular lens sheet according to the present invention.

[FIG. 12E] A schematic view showing an exemplary structure of a lenticular lens sheet according to the present invention.

[FIG. 12F] A schematic view showing an exemplary structure of a lenticular lens sheet according to the present invention.

[FIG. 12G] A schematic view showing an exemplary structure of a lenticular lens sheet according to the present invention.

[FIG. 12H] A schematic view showing an exemplary structure of a lenticular lens sheet according to the present invention.

[FIG. 12I] A schematic view showing an exemplary structure of a lenticular lens sheet according to the present invention.

[FIG. 12J] A schematic view showing an exemplary structure of a lenticular lens sheet according to the present invention.

[FIG. 12K] A schematic view showing an exemplary structure of a lenticular lens sheet according to the present invention.

[FIG. 13] A table showing implementation results of a rear projection screen according to the present invention.

[FIG. 14] A table showing implementation results of a rear projection screen according to the present invention.

[FIG. 15] A table showing implementation results of a rear projection screen according to the present invention.

[FIG. 16] A table showing implementation results of a rear projection screen according to the present invention.

[FIG. 17] A table showing implementation results of a rear projection screen according to the present invention.

[FIG. 18] A table showing implementation results of a rear projection screen according to the present invention.

### DESCRIPTION OF REFERENCE NUMERALS

1 Rear projection screen,
11 Lenticular lens sheet
110 Lenticular lens
12 Fresnel lens sheet
120 Fresnel lens
121 Light incident surface
122 Fresnel surface
13 Light shielding pattern
15, 21 Pixel
151, 210 Valid pixel area
30 Lenticular lens sheet
111 Output lens
40 Lenticular lens sheet
41 Front panel
42 Adhesive layer
45 Lenticular lens sheet
46 Wedgy reflection plane
460 Wedge portion
51 Lenticular lens sheet
510 Lenticular lens
511 Concave output lens
52 Lenticular lens sheet
521 Output lens
53 Lenticular lens sheet
531 Micro lens
54 Lenticular lens sheet
540 Lenticular lens
541 Output lens
55, 56, 57, 575, 58 Lenticular lens sheet
570, 580 Lenticular lens
561, 571 Wedge portion
581 Tint layer
576 Light shielding layer
577 Output plane depressed portion
578 Output portion
59 Lenticular lens sheet
590 Wedge portion
591-593 Lens element
594-596 Output portion

### BEST MODES FOR CARRYING OUT THE INVENTION

Preferred embodiments of the present invention are described hereinafter with reference to the drawings.

### First Embodiment

Referring first to FIG. 1, the structure of a rear projection screen according to the present invention is described hereinafter. FIG. 1 is a sectional view showing an exemplary structure of a rear projection screen according to the present invention. As shown in FIG. 1, a rear projection screen 1 includes a lenticular lens sheet 11, a Fresnel lens sheet 12, and a light shielding pattern 13.

The lenticular lens sheet 11 is a sheet in which a lenticular lens 110 is formed on a light incident surface. The lenticular lens 110 is composed of a plurality of vertical cylindrical lenses, each having a barrel shape, which are arranged regularly.

The Fresnel lens sheet 12 is a sheet in which a Fresnel lens 120 is formed on a light output surface. The Fresnel lens 120 has a set of concentric annular zones arranged regularly with a fine pitch. The Fresnel lens sheet 12 is described in detail later.

The light shielding pattern 13 is a light absorbing layer of black ink or the like. The light shielding pattern 13 is placed at positions other than light focusing portions by the lenticular lens 110.

As shown in FIG. 1, the lens sheets 11 and 12 are placed in close proximity to each other, thereby constituting the rear projection screen 1. In the rear projection screen 1, light from a rear projection projector, which is not shown, enters through the side opposite to the Fresnel lens 120. The incident light passes through the Fresnel lens sheet 12 and exits through the Fresnel lens 120. The output parallel or convergent light is diffused largely in the horizontal direction by the lenticular lens sheet 11. This enables the observation of a video in a wide viewing range along the horizontal direction.

Referring next to FIG. 2, pixels in the rear projection screen 1 according to the present invention are described hereinafter. FIG. 2 is a schematic plan view showing pixels in the rear projection screen 1 according to the present invention. As shown in FIG. 2, a pixel 15 of the rear projection screen 1 according to the present invention has a rhombus shape. Specifically, each pixel 15 has a shape that a rectangular pixel is inclined when observed from the viewing side. A plurality of pixels 15 are arranged in the inclined position in such a way that their sides are substantially in parallel with each other. Thus, the pixels 15 are arranged in being inclined along the direction of inclination. In other words, the pixels 15 are the inclined version of pixels that are arranged horizontally and vertically in the conventional manner.

Referring then to FIGS. 3A and 3B, the characteristics of the pixel 15 according to the present invention are described hereinbelow. Particularly, the content of harmonics in the pixel 15 of the present invention and a pixel of a related art is described with reference to FIGS. 3A and 3B. FIG. 3A is a schematic view showing the pixel 15 of the present invention, and FIG. 3B is a schematic view showing a pixel of a related art. In this example, a pixel 21 of a related art is described as a square pixel as shown in FIG. 3B.

As shown in FIG. 3A, the pixel 15 that is placed in the being inclined is equivalent to the pixel 21 in the square shape which is rotated at 45°. Thus, if the pixel width of the pixel 21 in the square shape is dT, the pixel width of the pixel 15 in the inclined position is about (√2)dT≈1.4 dT.

Although the pixel arrangement period of the pixel 21 in the square shape is the length of one side of the square, that of the pixels 15 which are arranged in the inclined position is half of the width in the horizontal direction. Therefore, if the pixel arrangement period of the pixel 21 in the square shape is T, the pixel arrangement period of the pixels 15 arranged in the inclined fashion is about (√2)T/2≈0.7 T.

It is assumed that the aperture ratio of the pixels 15 and 21 is 64%, and valid pixel areas 150 and 210 of the pixels 15 and 21, respectively, have a uniform luminance. In this case, the aperture ratio of 64% means that a duty factor (which is abbreviated hereinafter as d) of the pixel 21 of a related art is 0.8. Further, x and y are a horizontal position coordinate and a vertical position coordinate, respectively, and a point of origin is at the center of a pixel as shown in FIGS. 3A and 3B.

A function of the pixel aperture shape of the pixel 21 in the square shape is represented by the following Expression (1):

$$\begin{matrix}[ Expression 1 ] & \\ fSuq ( x , y ) = \{ \begin{matrix}\frac{1}{{( 0.8 T )}^{2}} & \begin{matrix}( where \vert x \vert < 0.5 dT = 0.4 T and \\ \vert y \vert < 0.5 dT = 0.4 T )\end{matrix} \\ 0 & \begin{matrix}( where \vert x \vert \geq 0.5 dT = 0.4 T or \\ \vert y \vert \geq 0.5 dT = 0.4 T )\end{matrix}\end{matrix} & ( 1 )\end{matrix}$$

In Expression (1), the denominator (0.8 T)² indicates normalization by the area of the aperture.

Fourier transform of Expression (1) gives the following Expression (2):

$$\begin{matrix}[ Expression 2 ] & \\ FSuq ( {f}_{x} , {f}_{y} ) = \frac{sin ( π {dTf}_{x} )}{π {dTf}_{x}} \cdot \frac{sin ( π {dTf}_{y} )}{π {dTf}_{y}} & ( 2 )\end{matrix}$$

where fₓ and f_{y} are a horizontal frequency and a vertical frequency, respectively.

If kₓ and k_{y} are the orders (integers) of horizontal and vertical harmonics, respectively, and fₓ=kₓ/T and f_{y}=k_{y}/T, the above Expression (2) is expressed as the following Expression (3):

$$\begin{matrix}[ Expression 3 ] & \\ FSuq ( \frac{{k}_{x}}{T} , \frac{{k}_{y}}{T} ) = \frac{sin ( π {dk}_{x} )}{π {dk}_{x}} \cdot \frac{sin ( π {dk}_{y} )}{π {dk}_{y}} & ( 3 )\end{matrix}$$

If a function of the pixel aperture shape of the pixel 15 in the inclined position is f_{Dia}, f_{Dia} is given by rotating the square at 45°, which is expressed as the following Expression (4):

$$\begin{matrix}[ Expression 4 ] & \\ fDia ( x , y ) = \{ \begin{matrix}\frac{1}{{( 0.8 T )}^{2}} & \begin{matrix}( where \vert x + y \vert < \frac{dT}{\sqrt{2}} \approx 0.56 T and \\ \vert x - y \vert < \frac{dT}{\sqrt{2}} \approx 0.56 T )\end{matrix} \\ 0 & \begin{matrix}( where \vert x + y \vert \geq \frac{dT}{\sqrt{2}} \approx 0.56 T or \\ \vert x - y \vert \geq \frac{dT}{\sqrt{2}} \approx 0.56 T )\end{matrix}\end{matrix} & ( 4 )\end{matrix}$$

Fourier transform of f_{Dia}(x, y) gives F_{Dia}(fₓ, f_{y}), which is expressed as the following Expression (5):

$$\begin{matrix}[ Expression 5 ] & \\ FDia ( {f}_{x} , {f}_{y} ) = \frac{sin ( π dT \frac{{f}_{x} + {f}_{y}}{\sqrt{2}} )}{π dT \frac{{f}_{x} + {f}_{y}}{\sqrt{2}}} \cdot \frac{sin ( π dT \frac{{f}_{x} - {f}_{y}}{\sqrt{2}} )}{π dT \frac{{f}_{x} - {f}_{y}}{\sqrt{2}}} & ( 5 )\end{matrix}$$

If kₓ and k_{y} are the orders (integers) of horizontal and vertical harmonics, respectively, and fₓ=(√2kₓ)/T and f_{y}=(√2k_{y})/T, the above Expression (5) is expressed as the following Expression (6):

$$\begin{matrix}[ Expression 6 ] & \\ FDia ( \frac{\sqrt{2} {k}_{x}}{T} , \frac{\sqrt{2} {k}_{y}}{T} ) = \frac{sin ( π d ( {k}_{x} + {k}_{y} ) )}{π d ( {k}_{x} + {k}_{y} )} \cdot \frac{sin ( π d ( {k}_{x} - {k}_{y} ) )}{π d ( {k}_{x} - {k}_{y} )} & ( 6 )\end{matrix}$$

In order to evaluate the interference with the lenticular lens 110 that is elongated in the vertical direction, the spectrum characteristics on the horizontal frequency axis at k_{y}=0 are specified in Expression (3) and Expression (6), it is expressed as the following Expressions (7) and (8), which correspond to Expressions (3) and (6), respectively.

$$\begin{matrix}[ Expression 7 ] & \\ \frac{sin ( π {dk}_{x} )}{π {dk}_{x}} & ( 7 ) \\ {\{ \frac{sin ( π {dk}_{x} )}{π {dk}_{x}} \}}^{2} & ( 8 )\end{matrix}$$

The tables of FIGS. 4 and 5 show a change in Expressions (7) and (8) with kₓ.

Referring to FIGS. 4 and 5, each harmonic component in the pixel 15 in the inclined position is attenuated in squares, compared with the pixel 21 in the square shape. Thus, if the pixels 15 are arranged in the inclined fashion in the rear projection screen 1, the interference with the lenticular lens 110 that is elongated in the direction perpendicular to the screen is suppressed, so that moire are less visible.

The pitch ratio Gp/Lp of the pixel pitch Gp of the pixel 15 with the lenticular pitch Lp preferably satisfies the following Expressions (9), (10):

Lp≧0.15 (9)

Gp/Lp≧1.0 (10)

More preferably, the pitch ratio Gp/Lp satisfies:

n+0.05≦Gp/Lp≦n+0.95 (11)

where n is a natural number.

If the pitch ratio Gp/Lp satisfies the above Expression (11), it is possible to suppress the occurrence of moire.

It is further preferred that the pitch ratio Gp/Lp satisfies any of the following Expressions (12) to (18). This makes a difference between the present invention and the related art more significant. In the following expressions, n is a natural number.

1.13≦Gp/Lp≦1.87 (12)

2.05≦Gp/Lp≦2.95 (13)

n+0.22≦Gp/Lp≦n+0.28 (14)

n+0.30≦Gp/Lp≦n+0.35 (15)

n+0.45≦Gp/Lp≦n+0.55 (16)

n+0.65≦Gp/Lp≦n+0.68 (17)

n+0.72≦Gp/Lp≦n+0.78 (18)

In the rear projection screen of a related art, moire is likely to appear if the pitch ratio Gp/Lp is approximately n+0.5 or it is a simple integral multiple. Accordingly, such a pitch ratio Gp/Lp has been considered to be unfavorable. On the other hand, in the rear projection screen 1 of the present invention, such a pitch ratio Gp/Lp, which is not preferred in the related art, also satisfies any one of the above Expressions (12) to (18) and thus does not substantially cause any problem of moire, so that the occurrence of moire can be suppressed. Further, it is preferred to satisfy Gp/Lp≧1.5 to exactly reproduce the fineness of a video.

Particularly, it is preferred that the pitch ratio Gp/Lp satisfies either one of the following Expressions (19) and (20):

1.30≦Gp/Lp≦1.70 (19)

2.30≦Gp/Lp (20)

Such a pitch ratio Gp/Lp allows suppression of light moire in a white screen.

It is more preferred that the pitch ratio Gp/Lp satisfies either one of the following Expressions (21) and (22):

1.40≦Gp/Lp≦1.60 (21)

2.47≦Gp/Lp (22)

Light moire in a white screen is often caused by low-order harmonics such as first-order moire and second-order moire. Therefore, the pitch ratio Gp/Lp that satisfies the above Expressions (21), (22) enables more reliable suppression of light moire.

Further, the pitch ratio Gp/Lp may satisfy either one of the following Expressions (23) and (24):

n+0.15≦Gp/Lp≦n+0.85 (23)

4.15≦Gp/Lp (24)

where a natural number is n=1, 2, 3.

Such a pitch ratio Gp/Lp allows suppression of dark moire.

Preferably, the pitch ratio Gp/Lp satisfies any one of the following Expressions (25) to (28):

1.40≦Gp/Lp≦1.60 (25)

2.47≦Gp/Lp≦2.85 (26)

3.15≦Gp/Lp≦3.85 (27)

4.15≦Gp/Lp (28)

Dark moire in a black screen is often caused by high-order harmonics such as four-order. Therefore, the pitch ratio Gp/Lp that satisfies the above Expressions (25) to (28), particularly Expression (28), enables more reliable suppression of dark moire. Further, because the pitch ratio Gp/Lp satisfies Expressions (19) to (22) in this case, it is possible to suppress not only dark moire but also light moire, thus enabling the suppression of both light and dark moire.

When the pitch ratio Gp/Lp satisfies 1.15≦Gp/Lp≦1.29 or 2.15≦Gp/Lp≦2.29, dark moire can be suppressed, though light moire cannot be suppressed in some cases.

When the pitch ratio Gp/Lp satisfies 1.3≦Gp/Lp≦1.39, 1.6≦Gp/Lp≦1.69, or 2.3≦Gp/Lp≦2.46, dark moire can be suppressed, and light moire can also be suppressed to be less visible.

The Fresnel lens sheet 12 of the rear projection screen 1 according to the present invention is described in detail hereinafter.

The Fresnel lens sheet 12 satisfies the diffusion characteristics that are expressed by the following Expressions (29) to (33):

ζ/α≦6 (29)

γ/α≦2.8 (30)

2.0°≦α≦5.5° (31)

γ≦12° (32)

ζ≦18° (33)

where α indicates a half-viewing angle, γ indicates a 1/10-viewing angle, and ζ indicates a 1/100-viewing angle.

As described in detail below, the use of the Fresnel lens sheet 12 having the diffusion characteristics that satisfy the above Expressions (29) to (33) enables suppression of an increase in the light intensity in the peripheral area while ensuring the diffusibility. The rear projection screen 1 of the present invention can thereby avoid the light loss while reducing speckle. This effect is described hereinafter in detail with reference to FIGS. 6A and 6B. FIGS. 6A and 6B are schematic views to describe the diffusion characteristics of the Fresnel lens sheet 12 according to the present invention.

The reduction of speckle and light loss in the present invention is achieved by remarking the 1/100-viewing angle ζ Referring to FIG. 6A, in the viewing angle region where the luminance is 1/100 of the front, the luminance is only 1/100 of that at the front. For this reason, the diffusion characteristics in this viewing angle region have been not regarded as important. However, even in the region at such an angle, a total amount of the outgoing light in the entire periphery at a certain angle range centering on the front direction is significantly larger than the amount expected from the luminance which is the light intensity in a certain direction only as shown in FIG. 6A.

This is because a total amount of light that is output in the direction at a certain angle θ is a product of a luminance value at the angle θ with a length of a perimeter on a unit spherical surface, which is a function of sin θ, as shown in FIG. 6B. Generally, as the diffusibility increases, not only the half-viewing angle α, but also the 1/100-viewing angle ζ increases accordingly. Thus, in such a wide angle, even a slight increase in luminance causes a large increase in the amount of light in the entire angle range.

If the diffusion characteristics of Expression (29) are not satisfied and the ratio ζ/α of the 1/100-viewing angle ζ with the half-viewing angle α is larger than 6, the proportion of light toward the periphery to the light toward the front and its vicinity is large. Accordingly, the proportion of light loss to the amount of outgoing light increases. The ratio ζ/α is preferably 4 or smaller to increase the proportion of light loss. This is the same when the diffusion characteristics of Expression (30) are not satisfied and the ratio γ/α of the 1/10-viewing angle γ with the half-viewing angle α is larger than 2.8. The ratio γ/α is preferably 2.2 or smaller to increase the proportion of light loss.

If the diffusion characteristics of Expression (31) are not satisfied and the half-viewing angle α is 2.0° or smaller, the diffusion characteristics are not sufficient, in which case a vertical viewing angle is narrow, and moire, ghost or the like cannot be suppressed sufficiently. If the diffusion characteristics of Expression (31) are not satisfied and the half-viewing angle α is 5.5° or larger, the viewing angle characteristics are too wide, in which case enough gain cannot be obtained. A preferred range of the half-viewing angle α is 4° to 5°.

If the diffusion characteristics of Expression (32),

(33) are not satisfied and the 1/100-viewing angle ζ is 18° or larger or the 1/10-viewing angle γ is 12° or larger, a trailing component of light that is absorbed by the light shielding pattern 13 is large. This results in a failure to obtain enough gain. More preferably, the 1/100-viewing angle ζ is 12° or larger. Otherwise, there may arise a problem that a screen abruptly becomes dark in a vertical viewing angle outside a certain range, which is called a hot-band phenomenon. For the same reason, the 1/10-viewing angle γ is preferably 7° or larger. A preferred range of the 1/100-viewing angle ζ is 12° to 15°.

In a related art, speckle is reduced by adding the diffusibility to the Fresnel lens sheet 12. If the diffusion characteristics of the Fresnel lens sheet 12 are enhanced, the amount of outgoing light that is blocked by the light shielding pattern 13 increases, which causes light loss.

On the other hand, the Fresnel lens sheet 12 of the present invention provides sufficient haze value and thus achieves a sufficiently wide vertical viewing angle. This enables reduction of speckle to thereby suppress moire. In addition, a trailing portion of the transmitted light which is absorbed by the light shielding pattern 13 after passing through the Fresnel lens sheet 12 is small. Light loss is thus small. It is thereby possible to achieve both suppression of light loss and reduction of speckle.

It is further preferred that the Fresnel lens sheet 12 of the present invention satisfies the following Expression (34). The main diffusibility of the Fresnel lens sheet 12 is obtained by the fine surface projections and depressions (which are also referred to simply as fine projections and depressions) on its light incident surface 121. It is thereby possible to largely suppress the occurrence of speckle due to the use of a diffusion material.

0.5 μm≦Ra≦2.0 μm (34)

where Ra is a center line average roughness that is specified by JIS B 0601.

In the present invention, if the surface roughness Ra is 0.5 μm or smaller, sufficient diffusion characteristics cannot be provided in some cases. If the surface roughness Ra is 2.0 μm or larger, speckle cannot be reduced sufficiently in some cases. Therefore, it is preferred that the Fresnel lens sheet 12 has the diffusion characteristics of Expression (34), and a more preferred range of the surface roughness Ra is 0.6 μm to 1.5 μm.

The fine projections and depressions on the light incident surface 121 of the Fresnel lens sheet 12 are preferably random. If the fine projections and depressions have some regularity, moire can be generated with a Fresnel lens array and/or a lenticular lens array.

FIG. 7 shows a schematic view to describe the diffusibility in the light incident surface 121 of the Fresnel lens sheet 12 according to the present invention. As shown in FIG. 7, when a light ray enters a diffusion sheet that contains a diffusion agent, the light ray is refracted by the diffusion agent that is contained inside. The refracted light ray is further refracted by the diffusion agent until it reaches the output surface. In this process, there is some light ray component which is diffused by the diffusion agent again and again to undergo the excessive diffusion. It is thereby difficult to suppress a trailing portion of the viewing angle which is diffused more than necessary.

On the other hand, when a light ray enters a sheet that diffuses light with the projections and depressions on the light incident surface 121, the diffusion characteristics are determined once the light ray is diffracted on the light incident surface 121. It is thereby possible to suppress a trailing portion of a viewing angle that is diffused. Further, according to the present invention, when ghost light that is reflected by a Fresnel surface 122 reaches the light incident surface 121 in FIG. 7, a component having an incident angle that is smaller than a critical angle is generated because the surface has projections and depressions. Therefore, only a part of ghost light can reach the output surface, thus suppressing ghost light.

Stray light that is reflected by the Fresnel surface 122 is not subject to total reflection by the light incident surface 121 of the Fresnel lens sheet 12 due to the fine projections and depressions. This enables significant suppression of double images. The effect of suppressing double images is particularly significant.

The proportion of the fine projections and depressions on the light incident surface 121 which contributes to the diffusion effect preferably satisfies

H1/H>0.5

where H is a measured haze value of the Fresnel lens sheet 12 of the present invention, and H1 is a measured haze value of the Fresnel lens sheet 12 which is the same as that of the present invention except that it does not contain a diffusion agent in a haze measurement method according to JIS-K7105. If it is outside this range, the proportion of the diffusion agent which contributes to the diffusion effect is large, in which case the effect of the present invention cannot be exerted sufficiently. More preferably, H1/H>0.8, and further preferably, H1/H>0.9.

It is not necessary to use the above-described lenticular lens sheet 11, and a microlens array in which fine independent lenses, rather than cylindrical lenses, are arranged in a lattice fashion may be used instead. Further, a lenticular lens in which cylindrical lenses are arranged horizontally and a lenticular lens in which cylindrical lenses are arranged vertically may be used in combination.

### Second Embodiment

A second embodiment of the invention describes another lenticular lens sheet according to the present invention. FIGS. 8A and 8B are sectional views showing another configuration example of the lenticular lens sheet according to the present invention.

Referring to FIG. 8A, a lenticular lens sheet 30 of this embodiment has an output lens 111.

A plurality of output lenses 111 are placed on the output surface of the lenticular lens sheet 30. The plurality of output lenses 111 are arranged at regular intervals and linearly elongated from the front to the back of the paper. Each output lens 111 is placed in close proximity to a focal point that is formed by the lenticular lens 110.

The light shielding patterns 13 of the lenticular lens sheet 30 according to this embodiment are placed between the output lenses 111. Each light shielding pattern 13 is formed on a projecting portion of the output surface of the lenticular lens sheet 30.

In the lenticular lens sheet 30 of this embodiment, the output lens 111 is preferably placed on the incident side compared with the focal point of the lenticular lens 110. Even if the optical axis of an incident lens and the optical axis of the output lens 111 are misaligned, this configuration prevents the incident light from entering the light shielding pattern portion to thereby enhance the light use efficiency, and also prevents the viewing angle range from being narrowed and the viewing angle characteristics from being asymmetrical.

Particularly when using the lenticular lens sheet 30 of the second embodiment, it is preferred that the pitch ratio Gp/Lp satisfies either one of the following Expressions (35) and (36):

1.30≦Gp/Lp≦1.90 (35)

2.20≦Gp/Lp (36)

Such a pitch ratio Gp/Lp allows suppression of light moire in a white screen.

It is more preferred that the pitch ratio Gp/Lp satisfies either one of the following Expressions (37) to (39):

1.34≦Gp/Lp≦1.70 (37)

1.75≦Gp/Lp≦1.85 (38)

2.35≦Gp/Lp (39)

It is further preferred that the pitch ratio Gp/Lp satisfies either one of the following Expressions (40) and (40):

1.40≦Gp/Lp≦1.50 (40)

2.50≦Gp/Lp (41)

Light moire in a white screen is often caused by low-order harmonics such as first-order moire and second-order moire. Therefore, the pitch ratio Gp/Lp that satisfies the above Expressions (40), (41) enables more reliable suppression of light moire.

Further, the pitch ratio Gp/Lp may satisfy either one of the following Expressions (42) to (44):

1.75<Gp/Lp<1.85 (42)

2.55≦Gp/Lp≦2.90 (43)

3.40≦Gp/Lp (44)

Such a pitch ratio Gp/Lp allows suppression of dark moire.

Preferably, the pitch ratio Gp/Lp satisfies either one of the following Expressions (45) and (46):

2.65≦Gp/Lp≦2.90 (45)

3.5≦Gp/Lp (46)

Particularly preferably, the pitch ratio Gp/Lp satisfies either one of the following Expressions (47) and (48):

2.65<Gp/Lp<2.90 (47)

3.50≦Gp/Lp (48)

Dark moire in a black screen is often caused by high-order harmonics of about second- to four-orders. Therefore, the pitch ratio Gp/Lp that satisfies, particularly, Expression (47), (48) enables more reliable suppression of dark moire. Further, because the pitch ratio Gp/Lp satisfies Expressions (36), (39), (41) in this case, it is possible to suppress not only dark moire but also light moire, thus enabling suppression of both light and dark moire.

### Third Embodiment

A third embodiment of the invention describes another lenticular lens sheet according to the present invention. FIG. 9 is a sectional view showing another configuration example of the lenticular lens sheet according to the present invention.

Referring to FIG. 9, a transparent front panel 41 is laminated onto a lenticular lens sheet 40 of this embodiment. The front panel 41 is laminated on the output surface of the lenticular lens sheet 40 and adhered by a transparent adhesive layer 42. The adhesive layer 42 is filled in depressed portions located between a plurality of lenticular lenses 110. The adhesive layer 42 may be formed with the use of a transparent ultraviolet curable resin, for example.

In the comparison in moire between the lenticular lens sheets 30 and 40 of the second and third embodiments, respectively, moire is suppressed more effectively in the lenticular lens sheet 30 of the second embodiment for the following reason.

As shown in FIG. 9, in the lenticular lens sheet 40 of the third embodiment, a focal length of the input lens is relatively short and the thickness of the sheet is small; therefore, it cannot stand on its own. On that account, the front panel is laminated on the output surface side. On the other hand, the lenticular lens sheet 30 of the second embodiment has a longer focal length of the input lens and a relatively larger thickness than the lenticular lens sheet 40 of the third embodiment.

The schematic views of FIGS. 10A and 10B show the contrasts that are observed from the output side when the light-dark pattern of a pixel period and the light-dark pattern of its harmonic pass through the Fresnel lens sheet 12 and the lenticular lens sheet 30, 40. If a focal length is long, a viewing diffusion angle is small, and the contrast of the light and dark patterns is weak. Accordingly, moire can be easily suppressed in the configuration with a long focal length of the input lens such as the lenticular lens sheet 30 of the second embodiment.

### Fourth Embodiment

A fourth embodiment of the invention describes another lenticular lens sheet according to the present invention. FIG. 11 is a sectional view showing another configuration example of the lenticular lens sheet according to the present invention.

Referring to FIG. 11, a reflection plane 46 having a wedge shape (which is referred to hereinafter simply as a wedgy reflection plane 46) is formed in a lenticular lens sheet 45 of this embodiment. The point of the wedgy reflection plane 46 faces toward the bottom of the lenticular

A wedge portion 460 is formed between the wedgy reflection planes 46. The wedge portion 460 is a region that is located between the wedgy reflection planes 46. The top surface of the wedge portion 460 is substantially flat, and it is in substantially the same plane as the output surface of the lenticular lens sheet 45. In other words, the top surface of the wedge portion 460 has substantially the same height as the output surface when measured from the incident surface of the lenticular lens 110.

The wedge portion 460 is filled with a radiation curable resin such as an acrylic ultraviolet curable resin having a lower refractive index than the lenticular lens sheet 11, for example, and it is buried inside the lenticular lens sheet 11. Alternatively, the wedge portion 460 may be filled with a light absorbing material that absorbs outside light with the use of a black material such as carbon particles.

### Other Embodiments

The present invention may be applied not only to the lenticular lens sheets that are described in the first to fourth embodiments of the invention, but also to lenticular lens sheets having various features. FIGS. 12A to 12K are sectional views showing exemplary structures of those lenticular lens sheets.

A lenticular lens sheet 51 shown in FIG. 12A is thickened compared with the lenticular lens sheet 11. Specifically, the curvature radius of a lenticular lens 510 that is placed in the incident side is larger than that of the lenticular lens 110. A concave output lens 511 that is placed between the light shielding patterns 13 is located at the position farther than a focal position of the lenticular lens 510 when viewed from the incident side to the incident side. A horizontal viewing angle is enlarged in such a lenticular lens sheet 51, and the lenticular lens sheet 51 with a long focal point can be configured. The lenticular lens sheet 51 can thereby stand on its own.

In a lenticular lens sheet 52 shown in FIG. 12B, a plurality of output lenses 521 are placed between the light shielding patterns 13. The output lenses 521 diffuse the outgoing light and thereby enlarge the viewing field.

A lenticular lens sheet 53 shown in FIG. 12C has a long focal point and is thus thickened just like the lenticular lens sheet 51. Specifically, the curvature radius of a lenticular lens 530 that is placed in the incident side is larger than that of the lenticular lens 110. Because the horizontal viewing angle decreases with an increase in the curvature radius, the lenticular lens sheet 53 has a large number of microlenses 531. The large number of microlenses 531 have a smaller lens pitch than the output lenses 521 of the lenticular lens sheet 52 shown in FIG. 12B. In such a structure, the lenticular lens sheet 53 can be thickened while maintaining an appropriate horizontal viewing angle even if optical axes are misaligned. The lenticular lens sheet 52 can thereby stand on its own.

In a lenticular lens sheet 54 shown in FIG. 12D, a plurality of output lenses 541 are placed substantially orthogonal to a lenticular lens 540. Specifically, the curvature radius of the output lenses 541 is smaller than that of the lenticular lens 540. In such a structure, the lenticular lens sheet 54 can be thickened, exhibit appropriate viewing angle characteristics and stand on its own.

Further, the lenticular lens sheet 54 may be fabricated by forming both the light incident surface and the light output surface at the same time. A mold that is used in the fabrication is produced by creating a trapezoidal groove for BS projection with a cut-off tool additionally to a mold on which the fine pattern of the lenticular lenses 540 is engraved by traverse cutting.

A lenticular lens sheet 55 shown in FIG. 12E is such that the light output portion of the lenticular lens sheet 45 according to the fourth embodiment of the invention is placed on the output side compared with the focal point of the lens 110. Specifically, the incident light ray is incident and reflected at a larger angle by the reflection portion 460 in the lenticular lens sheet 55, thus enlarging the viewing angle.

A lenticular lens sheet 56 shown in FIG. 12F has a large number of wedge portions 561. This keeps appropriate viewing angle characteristics even when optical axes are misaligned.

A lenticular lens sheet 57 shown in FIG. 12G uses a lens capable of suppressing moire as a lenticular lens 570. If the wedge portion 571 has substantially a trapezoidal shape with its front edge being flat or curved, the creation of a molding tool and the release of a molded product are easy.

In a lenticular lens sheet 575 shown in FIG. 12H, a light shielding layer 576 is formed in an output surface depressed portion 577. The lenticular lens sheet 575 in such a structure has the advantage that the formation of the light shielding layer 576 is easy. Specifically, after forming a lenticular lens sheet having a projecting output portion 578, a black ink, for example, is applied onto the output surface. Then, the black ink is scraped off with the use of scraping means such as a roll or a blade, thereby forming the light shielding layer 576 in the output surface depressed portion 577. A front panel or the like may be laminated on the output surface side.

In a lenticular lens sheet 58 shown in FIG. 12I, a tint layer 581 is placed on the incident surface side of a lenticular lens 580. Preferably, the tint layer 581 is shaped along the lens shape of the lenticular lens 580. This suppresses the attenuation of incident video light and effectively attenuates outside light that is retroreflected along the lens shape.

A lenticular lens sheet 59 shown in FIG. 12J splits the incident light into three beams. An incident lens of the lenticular lens sheet 59 has three lens elements (a lens central portion 591, a lens right portion 592, and a lens left portion 593) with different focal positions, which are placed at the center, the right side and the left side, respectively, of the lens in connection with each other.

The video light that is incident on the lens central portion 591 is output through an opposing output portion 594 and contributes to the video light emission at the horizontal viewing angle in the vicinity of the front part of a screen. On the other hand, the video light that is incident on the lens right portions 592, 593 that are located at lens valley portions is output through output portions 595, 596 that are adjacent to the opposing output portion 594 and contributes to the video light emission at the horizontal viewing angle in the vicinity of the right and left part of the screen. In the lenticular lens sheet 59 of such a structure, the sheet thickness and the lens shape are designed so that the horizontal viewing angle range in the vicinity of the front and in the vicinity of the left and right of the lens is substantially continuous and there is no step in luminance.

The schematic view of FIG. 12K shows the viewing angle in the lens element. In FIG. 12K, a central part 597 indicates the viewing angle of a light ray that enters through the lens central portion 591 and is output through the output portion 594, and a right part 598 and a left part 599 indicate the viewing angle of light ray that enters through the lens right portion 592, the lens left portion 593 and is output through the output portion 595, 596, respectively. As shown in FIG. 12K, an output portion of the light ray that is incident on an incident lens of one unit that is composed of three lens elements (591 to 593) is switched from the output portion 594 to the output portion 595, 596 at each boundary between the lens central portion 591, the lens right portion 592 and the lens left portion 593.

By designing a lens so that the switching and the overlapping of the viewing angle ranges are appropriate as shown in FIG. 12K, it is possible to prevent the reduction of resolution. In such a design, the focal position can be separated from the lenticular lens 59, which enables a longer focal point, thickening, and self-standing. Further, if a wedge portion 590 has a substantially trapezoidal shape with its front edge being flat or curved as in the lenticular lens sheet 59, the creation of a molding tool and the release of a molded product are easy.

Examples of the rear projection screen 1 according to the present invention are described hereinafter.

In the following examples, a lenticular lens sheet having a different pitch was combined with a Fresnel lens sheet and mounted on a projection TV. Then, a white image or a black image was projected to thereby evaluate moire. The Fresnel lens sheet has a haze of 58%. The degree of moire was checked by visual identification in the examples below.

Examples 1 to 3 and 6 to 8 relate to the suppression of light moire, and examples 4, 5, 9 and 10 relate to the suppression of dark moire. The examples 6 to 10 provide the comparison between the lenticular lens sheets 30 and 40 of the second and third embodiments, respectively.

### EXAMPLES

### Example 1

The table of FIG. 13 shows results in the example 1. As shown in FIG. 13, when the lenticular pitch Lp is 0.15 mm and the pixel size Gp is 0.9685 mm, the pitch ratio Gp/Lp is 6.457. In this case, moire was suppressed. Further, when the lenticular pitch Lp is 0.295 mm and the pixel size Gp is 0.9685 mm (the pitch ratio Gp/Lp is 3.283) and when the lenticular pitch Lp is 0.518 mm and the pixel size Gp is 0.8648 mm (the pitch ratio Gp/Lp is 1.669), moire was suppressed. The pixel size in the example 1 is a size corresponding to a pixel arrangement period shown in FIG. 3A.

Furthermore, when the lenticular pitch Lp is 0.625 mm and the pixel size Gp is 0.9685 mm (the pitch ratio Gp/Lp is 1.550) and when the lenticular pitch Lp is 0.721 mm and the pixel size Gp is 0.9685 mm (the pitch ratio Gp/Lp is 1.343), moire was suppressed.

As described above, in the rear projection screen 1 of the present invention, light moire can be suppressed by setting the pixel size Gp, the lenticular pitch Lp and the pitch ratio Gp/Lp to satisfy the above Expressions (9) to (18).

### Example 2

In the example 2, light moire was checked with the use of the rear projection screen 1. In the rear projection screen 1 of the example 2, the number of pixels 15 arranged in the inclined position was 1280 pixels×720 pixels. The table of FIG. 14 shows results in the example 2.

In FIG. 14, the configuration in which moire was not visible by checking in package is indicated by “∘”, and the configuration in which moire was visible by checking in package is indicated by “x”. Further, in FIG. 14, the configuration in which moire was invisibly identified is indicated by “Δ”. FIG. 14 also shows results regarding dark moire, which are described in the following example 4.

Specifically, as shown in FIG. 14, when the lenticular pitch Lp is 0.15 mm, 0.265 mm, 0.295 mm (0.15 mm or lager), all the pitch ratio Gp/Lp was higher than 1.0. Light moire was not visible in the rear projection screen 1 of those cases.

When the lenticular pitch Lp is 0.311 mm (0.15 mm or lager), all the pitch ratio Gp/Lp was higher than 1.0, and light moire was not visible in most cases. On the other hand, when the pitch ratio Gp/Lp is 2.31 and 2.37, light moire was visually recognized but was hardly visible.

When the lenticular pitch Lp is 0.322 mm (0.15 mm or lager), all the pitch ratio Gp/Lp was higher than 1.0, and light moire was not visible except when the pitch ratio Gp/Lp is 2.23 and 2.29. On the other hand, when the pitch ratio Gp/Lp is 2.23 and 2.29, light moire was visually recognized but was hardly visible.

When the lenticular pitch Lp is 0.52 mm (0.15 mm or lager), all the pitch ratio Gp/Lp was higher than 1.0, and light moire was not visible when the pitch ratio Gp/Lp is 1.42 to 1.59 and 2.49 to 2.59. On the other hand, when the pitch ratio Gp/Lp is 1.38, 1.63 to 1.69, and 2.32 to 2.46, light moire was visually recognized but was hardly visible. Further, when the pitch ratio Gp/Lp is 1.73 to 2.28, light moire was visible.

When the lenticular pitch Lp is 0.625 mm (0.15 mm or lager), all the pitch ratio Gp/Lp was higher than 1.0, and light moire was not visible when the pitch ratio Gp/Lp is 1.41 to 1.61. On the other hand, when the pitch ratio Gp/Lp is 1.30 to 1.38 and 1.64 to 1.70, light moire was visually recognized but was hardly visible. Further, when the pitch ratio Gp/Lp is 1.15 to 1.27 and 1.73 to 2.16, light moire was visible.

As described above, in the rear projection screen 1 of the present invention, light moire can be suppressed by setting the pixel size Gp, the lenticular pitch Lp and the pitch ratio Gp/Lp to satisfy the above Expressions (9) to (18).

### Example 3

In the example 3, light moire was checked with the use of the rear projection screen 1. In the rear projection screen 1 of the example 3, the number of pixels 15 arranged in the inclined position was 1920 pixels×1080 pixels.

The table of FIG. 15 shows results in the example 3. In the example 3, the configuration in which moire was not visible by checking in package is indicated by “∘”, and the configuration in which moire was visible by checking in package is indicated by “x”. Further, in FIG. 15, the configuration in which moire was invisibly identified is indicated by “Δ”. In FIG. 15, the fields where checking was not performed are blank. FIG. 15 also shows results regarding dark moire, which are described in the following example 5.

Specifically, as shown in FIG. 15 when the lenticular pitch Lp is 0.15 mm, all the pitch ratio Gp/Lp was higher than 1.0. Light moire was not visible in the rear projection screen 1 of those cases.

When the lenticular pitch Lp is 0.265 mm (0.15 mm or lager), all the pitch ratio Gp/Lp was higher than 1.0, and light moire was not visible except when the pitch ratio Gp/Lp is 1.81 to 2.44. On the other hand, when the pitch ratio Gp/Lp is 2.31 to 2.44, light moire was visually recognized but was hardly visible. Further, when the pitch ratio Gp/Lp is 1.81 to 2.26, light moire was visible.

When the lenticular pitch Lp is 0.295 mm (0.15 mm or lager), all the pitch ratio Gp/Lp was higher than 1.0, and light moire was not visible except when the pitch ratio Gp/Lp is 1.63 to 2.44. On the other hand, when the pitch ratio Gp/Lp is 1.63, 1.67, and 2.32 to 2.44, light moire was visually recognized but was hardly visible. Further, when the pitch ratio Gp/Lp is 1.71 to 2.28, light moire was visible.

When the lenticular pitch Lp is 0.311 mm (0.15 mm or lager), all the pitch ratio Gp/Lp was higher than 1.0, and light moire was not visible except when the pitch ratio Gp/Lp is 1.62 to 2.47. On the other hand, when the pitch ratio Gp/Lp is 1.62 to 1.70 and 2.31 to 2.47, light moire was visually recognized but was hardly visible. Further, when the pitch ratio Gp/Lp is 1.74 to 2.27, light moire was visible.

When the lenticular pitch Lp is 0.52 mm (0.15 mm or lager), all the pitch ratio Gp/Lp was higher than 1.0, and light moire was not visible except when the pitch ratio Gp/Lp is 1.01 to 1.38 and 1.61 to 1.73. On the other hand, when the pitch ratio Gp/Lp is 1.31 to 1.38 and 1.61 to 1.68, light moire was visually recognized but was hardly visible. Further, when the pitch ratio Gp/Lp is 1.01 to 1.29, 1.71 and 1.73, light moire was visible.

As described above, in the rear projection screen 1 of the present invention, light moire can be suppressed by setting the pixel size Gp, the lenticular pitch Lp and the pitch ratio Gp/Lp to satisfy the above Expressions (9) to (18).

### Example 4

In the example 4, dark moire was checked with the use of the rear projection screen 1 of the example 2. The table of FIG. 14 shows results in the example 4 in addition to the results in the example 2.

As shown in FIG. 14, when the lenticular pitch Lp is 0.265 mm (0.15 mm or lager), dark moire was not visible except when the pitch ratio Gp/Lp is 2.92 to 3.12 and 3.94 to 4.14. On the other hand, dark moire was visible when the pitch ratio Gp/Lp is 2.92 to 3.12 and 3.94 to 4.14.

When the lenticular pitch Lp is 0.311 mm (0.15 mm or lager), dark moire was not visible except when the pitch ratio Gp/Lp is 2.89 to 3.12 and 3.88 to 4.11. On the other hand, dark moire was visible when the pitch ratio Gp/Lp is 2.89 to 3.12 and 3.88 to 4.11.

As described above, in the rear projection screen 1 of the present invention, dark moire, in addition to light moire, can be suppressed by setting the pixel size Gp, the lenticular pitch Lp and the pitch ratio Gp/Lp to satisfy the above Expressions (9) to (28).

### Example 5

In the example 5, dark moire was checked with the use of the rear projection screen 1 of the example 3. The table of FIG. 15 shows results in the example 5 in addition to the results in the example 3.

As shown in FIG. 15, when the lenticular pitch Lp is 0.265 mm (0.15 mm or lager), dark moire was not visible except when the pitch ratio Gp/Lp is 1.86 to 2.13 and 2.85 to 3.12. On the other hand, dark moire was visible when the pitch ratio Gp/Lp is 1.86 to 2.13 and 2.85 to 3.12.

When the lenticular pitch Lp is 0.311 mm (0.15 mm or lager), dark moire was not visible except when the pitch ratio Gp/Lp is 1.85 to 2.12 and 2.89. On the other hand, dark moire was visible when the pitch ratio Gp/Lp is 1.85 to 2.12 and 2.89.

As described above, in the rear projection screen 1 of the present invention, dark moire, in addition to light moire, can be suppressed by setting the pixel size Gp, the lenticular pitch Lp and the pitch ratio Gp/Lp to satisfy the above Expressions (9) to (28).

### Example 6

In an example 6, the evaluation is performed on five kinds of lenticular lens sheets having the lenticular pitch Lp of 0.15 mm, 0.295 mm, 0.518 mm, 0.625 mm and 0.721 mm. The lenticular lens sheets having the lenticular pitch Lp of 0.15 mm and 0.295 mm are lenticular lens sheets with a single-sided lens according to the third embodiment, and the lenticular lens sheets having the lenticular pitch Lp of 0.518 mm, 0.625 mm and 0.721 mm are lenticular lens sheets where lenticular lenses are formed on both surfaces according to the second embodiment.

The table of FIG. 16 shows results in the example 6. In FIG. 16, the configuration in which moire was not visible by checking in package is indicated by “∘”, and the configuration in which moire was visible by checking in package is indicated by “x”. Further, the configuration in which moire was invisibly identified is indicated by “Δ”

As shown in FIG. 16, when the lenticular pitch Lp is 0.15 mm and the pixel size Gp is 0.9685 mm, the pitch ratio Gp/Lp is 6.457. In this case, moire was suppressed.

Further, when the lenticular pitch Lp is 0.295 mm and the pixel size Gp is 0.9685 mm (the pitch ratio Gp/Lp is 3.283), moire was suppressed.

When the lenticular pitch Lp is 0.518 mm and the pixel size Gp is 0.8648 mm (the pitch ratio Gp/Lp is 1.669), moire was suppressed. When the pixel size Gp is 0.9685 mm (the pitch ratio Gp/Lp is 1.87), moire was suppressed to an invisible level. The pixel size in the example 6 is a size corresponding to a pixel arrangement period shown in FIG. 3A.

Further, when the lenticular pitch Lp is 0.625 mm and the pixel size Gp is 0.9685 mm (the pitch ratio Gp/Lp is 1.550) and when the lenticular pitch Lp is 0.721 mm and the pixel size Gp is 0.9685 mm (the pitch ratio Gp/Lp is 1.343), moire was suppressed.

As described above, in the rear projection screen 1 of the present invention, light moire can be suppressed by setting the pixel size Gp, the lenticular pitch Lp and the pitch ratio Gp/Lp to satisfy the above expressions (35) to (41).

### Example 7

In the example 7, light moire was checked with the use of the rear projection screen 1. In the rear projection screen 1 of the example 7, the number of pixels 15 arranged in the inclined position was 1280 pixels×720 pixels.

In the example 7, the evaluation is performed on seven kinds of lenticular lens sheets having the lenticular pitch Lp of 0.15 mm, 0.265 mm, 0.295 mm, 0.311 mm, 0.322 mm, 0.518 mm and 0.625 mm. For the lenticular lens sheets having the lenticular pitch Lp of 0.15 mm, 0.265 mm, 0.295 mm and 0.311 mm, the lenticular lens sheet according to the third embodiment was used. For the lenticular lens sheets having the lenticular pitch Lp of 0.265 mm, 0.311 mm, 0.518 mm and 0.625 mm, the lenticular lens sheet according to the second embodiment was used.

The table of FIG. 17 shows results in the example 7. In FIG. 17, just like FIG. 16, the configuration in which moire was not visible by checking in package is indicated by “∘”, and the configuration in which moire was visible by checking in package is indicated by “x”. Further, the configuration in which moire was invisibly identified is indicated by “Δ”. FIG. 17 also shows results regarding dark moire, which are described in the following example 9.

Specifically, as shown in FIG. 17, when the lenticular pitch Lp is 0.15 mm, 0.265 mm, 0.295 mm (0.15 mm or lager), all the pitch ratio Gp/Lp was higher than 1.0. Light moire was not visible in the rear projection screen 1 of those cases.

In the lenticular lens sheet of the third embodiment, when the lenticular pitch Lp is 0.311 mm (0.15 mm or lager), all the pitch ratio Gp/Lp was higher than 1.0, and light moire was not visible in most cases. When the pitch ratio Gp/Lp is 2.31 and 2.37, light moire was visible. When the pitch ratio Gp/Lp is 2.43, 2.49 and 2.54, light moire was visually recognized but was hardly visible.

In the lenticular lens sheet of the second embodiment, when the lenticular pitch Lp is 0.311 mm (0.15 mm or lager), light moire was not visible in all the ranges of the pitch ratio Gp/Lp 2.31 to 4.34.

When the lenticular pitch Lp is 0.322 mm (0.15 mm or lager), all the pitch ratio Gp/Lp was higher than 1.0.

Light moire was not visible except when the pitch ratio Gp/Lp is 2.23 and 2.29. When the pitch ratio Gp/Lp is 2.35 and 2.40, light moire was visually recognized but was hardly visible.

When the lenticular pitch Lp is 0.52 mm (0.15 mm or lager), all the pitch ratio Gp/Lp was higher than 1.0, and light moire was not visible when the pitch ratio Gp/Lp is 1.38 to 1.69 and 2.32 to 2.59. When the pitch ratio Gp/Lp is 1.38, 1.63 to 1.69, and 2.32 to 2.46, light moire was visually recognized but was hardly visible. On the other hand, when the pitch ratio Gp/Lp is 1.73 to 2.28, light moire was visible.

When the lenticular pitch Lp is 0.625 mm (0.15 mm or lager), all the pitch ratio Gp/Lp was higher than 1.0, and light moire was not visible when the pitch ratio Gp/Lp is 1.30 to 1.70. When the pitch ratio Gp/Lp is 1.30 to 1.38 and 1.64 to 1.70, light moire was visually recognized but was hardly visible. On the other hand, when the pitch ratio Gp/Lp is 1.15 to 1.27 and 1.73 to 2.16, light moire was visible.

As described above, in the rear projection screen 1 of the present invention, light moire can be suppressed by setting the pixel size Gp, the lenticular pitch Lp and the pitch ratio Gp/Lp to satisfy the above Expressions (35) to (41).

### Example 8

In the example 8, light moire was checked with the use of the rear projection screen 1. In the rear projection screen 1 of the example 8, the number of pixels 15 arranged in the inclined position was 1920 pixels×1080 pixels.

In the example 8, the evaluation is performed on five kinds of lenticular lens sheets having the lenticular pitch Lp of 0.15 mm, 0.265 mm, 0.295 mm, 0.311 mm, and 0.518 mm. For the lenticular lens sheets having the lenticular pitch Lp of 0.15 mm, 0.265 mm, 0.295 mm and 0.311 mm, the lenticular lens sheet according to the third embodiment was used. For the lenticular lens sheets having the lenticular pitch Lp of 0.265 mm, 0.311 mm and 0.518 mm, the lenticular lens sheet according to the second embodiment was used.

The table of FIG. 18 shows results in the example 8. In the example 8, the configuration in which moire was not visible by checking in package is indicated by “∘”, and the configuration in which moire was visible by checking in package is indicated by “x”. Further, in FIG. 18, the configuration in which moire was invisibly identified is indicated by “Δ”. In FIG. 18, the fields where checking was not performed are blank. FIG. 18 also shows results regarding dark moire, which are described in the following example 10.

Specifically, as shown in FIG. 18, when the lenticular pitch Lp is 0.15 mm, all the pitch ratio Gp/Lp was higher than 1.0. Light moire was not visible in the rear projection screen 1 of those cases.

In the lenticular lens sheet of the third embodiment, when the lenticular pitch Lp is 0.265 mm (0.15 mm or lager), all the pitch ratio Gp/Lp was higher than 1.0, and light moire was not visible except when the pitch ratio Gp/Lp is 1.95 to 2.44. When the pitch ratio Gp/Lp is 1.81 to 1.90 and 2.49 to 2.53, light moire was visually recognized but was hardly visible. On the other hand, when the pitch ratio Gp/Lp is 1.95 to 2.44, light moire was visible.

In the lenticular lens sheet of the second embodiment, when the lenticular pitch Lp is 0.265 mm (0.15 mm or lager), all the pitch ratio Gp/Lp was higher than 1.0, and light moire was not visible except when the pitch ratio Gp/Lp is 2.04 to 2.17. When the pitch ratio Gp/Lp is 2.22 to 2.26, light moire was visually recognized but was hardly visible. On the other hand, when the pitch ratio Gp/Lp is 2.04 to 2.17, light moire was visible.

When the lenticular pitch Lp is 0.295 mm (0.15 mm or lager), all the pitch ratio Gp/Lp was higher than 1.0, and light moire was not visible except when the pitch ratio Gp/Lp is 1.63 to 1.71 and 1.91 to 2.40. When the pitch ratio Gp/Lp is 1.75 to 1.87 and 2.44 to 2.52, light moire was visually recognized but was hardly visible. On the other hand, when the pitch ratio Gp/Lp is 1.63 to 1.71 and 1.91 to 2.40, light moire was visible.

In the lenticular lens sheet of the third embodiment, when the lenticular pitch Lp is 0.311 mm (0.15 mm or lager), all the pitch ratio Gp/Lp was higher than 1.0, and light moire was not visible except when the pitch ratio Gp/Lp is 1.54 to 1.74 and 1.89 to 2.39. When the pitch ratio Gp/Lp is 1.77 to 1.85 and 2.43 to 2.54, light moire was visually recognized but was hardly visible. On the other hand, when the pitch ratio Gp/Lp is 1.54 to 1.74 and 1.89 to 2.39, light moire was visible.

In the lenticular lens sheet of the second embodiment, when the lenticular pitch Lp is 0.311 mm (0.15 mm or lager), all the pitch ratio Gp/Lp was higher than 1.0, and light moire was not visible except when the pitch ratio Gp/Lp is 2.00 to 2.20. When the pitch ratio Gp/Lp is 2.24 to 2.27, light moire was visually recognized but was hardly visible. On the other hand, when the pitch ratio Gp/Lp is 2.00 to 2.20, light moire was visible.

When the lenticular pitch Lp is 0.52 mm (0.15 mm or lager), all the pitch ratio Gp/Lp was higher than 1.0 except for a screen size of 40 to 43 inch, and light moire was not visible except when the pitch ratio Gp/Lp is 1.01 to 1.29 and 1.71 to 1.73. When the pitch ratio Gp/Lp is 1.31 to 1.38 and 1.61 to 1.68, light moire was visually recognized but was hardly visible. On the other hand, when the pitch ratio Gp/Lp is 1.01 to 1.29, 1.71, and 1.73, light moire was visible.

As described above, in the rear projection screen 1 of the present invention, light moire can be suppressed by setting the pixel size Gp, the lenticular pitch Lp and the pitch ratio Gp/Lp to satisfy the above Expressions (35) to (41).

### Example 9

In the example 9, dark moire was checked with the use of the rear projection screen 1 of the example 7. The table of FIG. 17 shows results in the example 9 in addition to the results in the example 7.

As shown in FIG. 17, in the lenticular lens sheet of the third embodiment, when the lenticular pitch Lp is 0.265 mm (0.15 mm or lager), dark moire was not visible except when the pitch ratio Gp/Lp is 2.99 to 3.33. When the pitch ratio Gp/Lp is 2.72, 2.78, 2.92, 3.39 and 3.46, dark moire was visually recognized but was hardly visible. On the other hand, when the pitch ratio Gp/Lp is 2.99 to 3.33, dark moire was visible.

As shown in FIG. 17, in the lenticular lens sheet of the second embodiment, when the lenticular pitch Lp is 0.265 mm (0.15 mm or lager), dark moire was not visible in all the ranges of the pitch ratio Gp/Lp 2.72 to 5.09.

In the lenticular lens sheet of the third embodiment, when the lenticular pitch Lp is 0.311 mm (0.15 mm or lager), dark moire was not visible except when the pitch ratio Gp/Lp is 2.31 to 2.60 and 2.95 to 3.47. When the pitch ratio Gp/Lp is 2.66 to 2.78 and 2.89, dark moire was visually recognized but was hardly visible. On the other hand, when the pitch ratio Gp/Lp is 2.31 to 2.60 and 2.95 to 3.47, dark moire was visible.

In the lenticular lens sheet of the second embodiment, when the lenticular pitch Lp is 0.311 mm (0.15 mm or lager), dark moire was not visible except when the pitch ratio Gp/Lp is 2.31 to 2.60. On the other hand, when the pitch ratio Gp/Lp is 2.31 to 2.60, dark moire was visible.

As described above, in the rear projection screen 1 of the present invention, dark moire, in addition to light moire, can be suppressed by setting the pixel size Gp, the lenticular pitch Lp and the pitch ratio Gp/Lp to satisfy the above Expressions (42) to (48).

### Example 10

In the example 10, dark moire was checked with the use of the rear projection screen 1 of the example 8. The table of FIG. 18 shows results in the example 10 in addition to the results in the example 8.

As shown in FIG. 18, in the lenticular lens sheet of the third embodiment, when the lenticular pitch Lp is 0.265 mm (0.15 mm or lager), dark moire was not visible except when the pitch ratio Gp/Lp is 1.86 to 2.53 and 2.99 to 3.35. When the pitch ratio Gp/Lp is 1.81, 2.58 to 2.76, 2.90, 2.94 and 3.39, dark moire was visually recognized but was hardly visible. On the other hand, when the pitch ratio Gp/Lp is 1.86 to 2.53 and 2.99 to 3.35, dark moire was visible.

In the lenticular lens sheet of the second embodiment, when the lenticular pitch Lp is 0.265 mm (0.15 mm or lager), dark moire was not visible except when the pitch ratio Gp/Lp is 1.81 to 2.58. On the other hand, when the pitch ratio Gp/Lp is 1.81 to 2.58, dark moire was visible.

In the lenticular lens sheet of the third embodiment, when the lenticular pitch Lp is 0.311 mm (0.15 mm or lager), dark moire was not visible except when the pitch ratio Gp/Lp is 1.54 to 2.58. When the pitch ratio Gp/Lp is 2.62 to 2.81 and 2.89, dark moire was visually recognized but was hardly visible. On the other hand, when the pitch ratio Gp/Lp is 1.54 to 2.58, dark moire was visible.

In the lenticular lens sheet of the second embodiment, when the lenticular pitch Lp is 0.311 mm (0.15 mm or lager), dark moire was not visible except when the pitch ratio Gp/Lp is 1.54 to 2.58. When the pitch ratio Gp/Lp is 2.62, dark moire was visually recognized but was hardly visible. On the other hand, when the pitch ratio Gp/Lp is 1.54 to 2.58, dark moire was visible.

As described above, in the rear projection screen 1 of the present invention, dark moire, in addition to light moire, can be suppressed by setting the pixel size Gp, the lenticular pitch Lp and the pitch ratio Gp/Lp to satisfy the above Expressions (42) to (48).

In the comparison in moire between the lenticular lens sheet of the third embodiment and the lenticular lens sheet of the second embodiment when the pitch Lp is 0.265 mm and 0.311 mm in the above-described examples 6 to 10, moire is suppressed more effectively in the lenticular lens sheet of the second embodiment.

### INDUSTRIAL APPLICABILITY

The present invention may be used in a rear projection display apparatus and, particularly, in a rear projection display apparatus in which each pixel has a rhombus shape that is inclined with respect to the horizontal direction and the vertical direction of a screen.

1. A rear projection screen comprising:
a plurality of pixels with an outer edge having a rhombus shape inclined with respect to a horizontal direction and a vertical direction of a screen of the rear projection screen; and
a lenticular lens sheet diffusing light emitted from a rear projection projector within a certain angle range, wherein
the plurality of pixels are arranged with the outer edge adjacent to each other,
a lens pitch Lp (mm) of the lenticular lens sheet satisfies Lp≧0.15, and
a pitch ratio Gp/Lp of a pitch Gp (mm) of the pixels and the lens pitch Lp satisfies Gp/Lp≧1.0.

2. The rear projection screen according to claim 1, wherein
the pitch ratio Gp/Lp satisfies n+0.05≦Gp/Lp≦n+0.95 where n is a natural number.

3. The rear projection screen according to claim 1, wherein
the pitch ratio Gp/Lp satisfies 1.30≦Gp/Lp≦1.70 or 2.30≦Gp/Lp.

4. The rear projection screen according to claim 1, wherein
the pitch ratio Gp/Lp satisfies 1.40≦Gp/Lp≦1.60 or 2.47≦Gp/Lp.

5. The rear projection screen according to claim 1, wherein
the pitch ratio Gp/Lp satisfies n+0.15≦Gp/Lp≦n+0.85 (n=1, 2, 3) or 4.15≦Gp/Lp.

6. The rear projection screen according to claim 1, wherein
the pitch ratio Gp/Lp satisfies any one of 1.40≦Gp/Lp≦1.60, 2.47≦Gp/Lp≦2.85, 3.15≦Gp/Lp≦3.85, and 4.15≦Gp/Lp.

7. The rear projection screen according to claim 1, wherein the lenticular lens sheet comprises:
a lenticular lens placed on a side where light emitted from the rear projection projector is incident and diffusing the incident light within a certain angle range; and
an output lens placed on a side where the incident light is output and diffusing light having passed through the lenticular lens within the certain angle range, wherein
the pitch ratio Gp/Lp satisfies 1.30≦Gp/Lp≦1.90 or 2.20≦Gp/Lp.

8. The rear projection screen according to claim 7, wherein
the pitch ratio Gp/Lp satisfies any one of 1.34≦Gp/Lp≦1.70, 1.75≦Gp/Lp≦1.85, and 2.35≦Gp/Lp.

9. The rear projection screen according to claim 7, wherein
the pitch ratio Gp/Lp satisfies 1.40≦Gp/Lp≦1.50 or 2.50≦Gp/Lp.

10. The rear projection screen according to claim 7, wherein
the pitch ratio Gp/Lp satisfies any one of 1.75<Gp/Lp<1.85, 2.55≦Gp/Lp≦2.90, and 3.40≦Gp/Lp.

11. The rear projection screen according to claim 7, wherein
the pitch ratio Gp/Lp satisfies 2.65≦Gp/Lp≦2.90 or 3.50≦Gp/Lp.

12. The rear projection screen according to claim 1, further comprising:
a Fresnel lens sheet narrowing light emitted from the rear projection projector to a certain angle range together with the lenticular lens sheet, wherein
the Fresnel lens sheet satisfies diffusion characteristics of ζ/α≦6 and γ/α≦2.8 where α indicates a half-viewing angle, γ indicates a 1/10-viewing angle, and ζ indicates a 1/100-viewing angle.

13. The rear projection screen according to claim 12, wherein
the Fresnel lens sheet satisfies diffusion characteristics of 2.0°≦α≦5.5°, γ≦12°, and ζ≦18°.

14. The rear projection screen according to claim 12, wherein
the Fresnel lens sheet has surface projections and depressions on an incident surface, and
a center line average roughness Ra specified by JIS B 0601 satisfies 0.5 μm≦Ra≦2.0 μm.

15. A rear projection display apparatus comprising the rear projection screen according to claim 1.
